(19) United States
(12) Patent Application Publication
(10) Pub. No.: US 2005/0071747 A1
(43) Pub. Date: Mar. 31, 2005

(54) Method and apparatus for performing multimedia operations

(76) Inventor: Denny Jaeger, Oakland, CA (US)

Correspondence Address: Wilson & Ham;PMB: 348, 2350 Berryessa Road, San Jose, CA, 95132, US

(21) Appl. No.: 10/953,053

(22) Filed: Sep. 28, 2004

Related U.S. Application Data
(60) Provisional application No. 60/506,815, filed on Sep. 28, 2003.

(51) Int. Cl. G06F 17/00

(52) U.S. Cl. 715/500.1

(57) ABSTRACT

A method for performing multimedia operations involves drawing a graphic directional indicator to establish a signal path between at least one graphical switch, such as a digital signal processing (DSP) or sound switch, and a graphic control device, such as another graphical switch or a fader.

### REFERENCE TO RELATED APPLICATION

This application claims the benefit of U.S. provisional patent application Ser. No. 60/506,815, filed Sep. 28, 2003, the disclosure of which is incorporated herein by reference.

### FIELD OF THE INVENTION

The invention relates generally to computer operations, and more particularly to a method for performing multimedia operations.

### BACKGROUND OF THE INVENTION

State of the art, audio production, mixing and editing software can be quite complicated on two levels: it can produce complicated audio signals and processing and it can be complicated to operate.

Regarding the first complication, means and methods that have become standard in the art over the last two decades have generally followed certain conventions as to how audio signals are routed and processed.

Regarding the second complication, the operation of audio software has typically not been an easy one. A large number of icons (which require explanation) and pull down menus and associated sub-menus, pop up task bars and associated menus and the like cause users to go through a wide number of often complicated steps to accomplish audio design, production, mixing and associated operations.

In view of these complications, there is a need for a method and apparatus for performing multimedia operations, which is easy to use by an average user.

### SUMMARY OF THE INVENTION

A method for performing multimedia operations involves drawing a graphic directional indicator to establish a signal path between at least one graphical switch, such as a digital signal processing (DSP) or sound switch, and a graphic control device, such as another graphical switch or a fader.

A method for performing multimedia operations in accordance with an embodiment of the invention comprises displaying at least one graphical switch having an associated function in a computer environment, drawing a graphic directional indicator in the computer environment, including associating the graphical switch with said graphic directional indicator, activating a transaction assigned to the graphic directional indicator, and establishing a signal or control path between the graphical switch and another element.

An embodiment of the invention includes a storage medium, readable by a computer, tangibly embodying a program of instructions executable by the computer to perform method steps for performing multimedia operations.

Other aspects and advantages of the present invention will become apparent from the following detailed description, taken in conjunction with the accompanying drawings, illustrated by way of example of the principles of the invention.

### BRIEF DESCRIPTION OF THE DRAWINGS

FIG. 1 illustrates the creation of a Delay switch in accordance with an embodiment of the invention.

FIG. 2 illustrates the creation of a Delay switch in accordance with another embodiment of the invention.

FIG. 3 depicts an Info Canvas object for a “EQ” DSP switch in accordance with an embodiment of the invention.

FIG. 4 is a flowchart describing the creation of a DSP switch in accordance with an embodiment of the invention.

FIG. 5 is a flowchart describing the creation of a sound switch in accordance with an embodiment of the invention.

FIG. 6 is a flowchart describing the activation of a sound switch in accordance with an embodiment of the invention.

FIGS. 7A and 7B show a flowchart of the process for drawing an arrow in Blackspace environment and applying an arrow logic in accordance with an embodiment of the invention.

FIG. 8 is a flowchart describing the use of contexts with an arrow logic in accordance with an embodiment of the invention.

FIG. 9a shows an arrow logic where the target object represents a sound source and the source object list contains objects representing both other sound sources and sound processing elements.

FIG. 9b shows an arrow logic where the target object represents a sound processing element and the source object list contains objects representing both sound sources and other sound processing elements.

FIG. 9c shows an arrow logic where the target object is a control device such as a fader, and the source list contains a number of objects representing sound sources.

FIG. 9d shows modifier text being used to dictate which feature of the sound sources should be controlled by the fader.

FIG. 9e shows an arrow logic where the target object represents a sound source and the source object list contains objects representing both other sound sources and a controlling device such as a fader.

FIG. 9f shows modifier text could be used to dictate which feature of the sound sources should be controlled by the fader.

FIG. 10a illustrates the drawing of a red control arrow which intersects four sound switches and points to a single fader.

FIG. 10b illustrates the turning on of a sound switch and having the volume setting for this switch change the position of the fader cap for the volume fader that is controlling that sound switch.

FIG. 10c illustrates the lassoing of multiple sound switches such that the fader can be used to modify the volume setting for all of these switches at once.

FIG. 11 is an example of a reverb DSP device in accordance with an embodiment of the invention.

FIG. 12a shows the process of creating a “mix” fader for three DSP switches in accordance with an embodiment of the invention.

FIG. 12b shows the result of the process of creating a “mix” fader for three DSP switches in accordance with an embodiment of the invention.

FIG. 13 illustrates how the “mix fader” gives a user access to the unprocessed signal and to the processed signal.

FIG. 14 shows a method of creating a “Show Switch” in accordance with an embodiment of the invention.

FIG. 15a shows the drawing of a gray “send” arrow from sound switch “Sound 2” to DSP switches “EQ” and “DELAY” to create a serial signal path in accordance with an embodiment of the invention.

FIG. 15b illustrates what happens when the SHOW switch for the Sound 2 switch has been turned on in accordance with an embodiment of the invention.

FIG. 15c show the drawing of two gray “send” arrows from SOUND 1 switch to the EQ and DELAY DSP switches, respectively, to create a parallel signal path in accordance with an embodiment of the invention.

FIG. 15d illustrates what happens when the SHOW switch for the Sound 1 switch has been turned on in accordance with an embodiment of the invention.

FIG. 16a shows a row of sound switches and a row of “Main” DSP switches.

FIG. 16b illustrates what happens when a toggle switch has been created and has been activated in accordance with an embodiment of the invention.

FIG. 16c illustrates that, when the toggle switch is turned off, the DSP switches revert to being controls for the Main DSP devices in accordance with an embodiment of the invention.

FIG. 17a shows three sound switches that have been created, a toggle switch that has been created and turned on, and a Sound 1 switch that has been activated, which automatically turns off all the other sound switches in accordance with an embodiment of the invention.

FIG. 17b shows Sound 2 switch that has been activated, which automatically turns off Sound 1 switch and the fader's value changes to show the value set for Sound 2 switch in accordance with an embodiment of the invention.

FIG. 18 illustrates the use of the Toggle Switch with DSP switches in accordance with an embodiment of the invention.

FIG. 19a is flowchart that describes the general operation of creating a toggle switch and operating it in accordance with an embodiment of the invention.

FIG. 19b is flowchart that describes the process of playing sounds in the toggle mode in accordance with an embodiment of the invention.

FIG. 19c is a flowchart that shows the process of exiting the toggle mode in accordance with an embodiment of the invention.

FIG. 20 depicts three sound sources, three DSP devices, a Save Me switch and a “combination” switch in accordance with an embodiment of the invention.

FIG. 21a shows DSP switches that are connected into a single signal path by drawing a gray arrow from each DSP switch to the switch below it in accordance with an embodiment of the invention.

FIG. 21b shows a signal path that is created by drawing a gray arrow from the EQ switch to the DELAY switch and back to the Reverb switch in accordance with an embodiment of the invention.

FIG. 21c illustrates how to establish different signal paths in accordance with an embodiment of the invention.

FIG. 21d illustrates how to operate the Save Me switch in accordance with an embodiment of the invention.

FIG. 22 is a flowchart that describes the creation and operation of the Save Me switch in accordance with an embodiment of the invention.

FIG. 23 is a flowchart that describes the use of the Combination switch in accordance with an embodiment of the invention.

FIG. 24a is a flowchart that shows the creation of a DSP fader output VDACC object in accordance with an embodiment of the invention.

FIG. 24b is a flowchart that describes how the output faders are removed in accordance with an embodiment of the invention.

FIG. 25 shows the result of right-clicking on a Combination switch to call forth its Info Canvas object in accordance with an embodiment of the invention.

FIG. 26a is a flowchart describing the process for obtaining a play bar for a sound switch in accordance with an embodiment of the invention.

FIG. 26b is a flowchart that describes what happens when the GUI receives a message from the sound system containing information about start and end times of the sound in accordance with an embodiment of the invention.

FIG. 27a illustrates the creation of a “Bright” text control in accordance with an embodiment of the invention.

FIG. 27b illustrates that whatever can be connected to a DSP device can be connected to a text control in accordance with an embodiment of the invention.

FIG. 27c illustrates a special geometry of the text control that is recognized by the software in accordance with an embodiment of the invention.

FIG. 27d illustrates one method of getting an Info Canvas object for the Brightness text control in accordance with an embodiment of the invention.

FIG. 28 is a flowchart of the process for creating a text control in accordance with an embodiment of the invention.

FIG. 29 is a flowchart that illustrates the setting up of a Text Control in accordance with an embodiment of the invention.

FIG. 30 is a flowchart that illustrates the operation of a text control in accordance with an embodiment of the invention.

FIG. 31 is a process flow diagram of a method for performing multimedia operations in accordance with an embodiment of the invention.

### DETAILED DESCRIPTION

The software of this invention is called TEHO™, which is a trademark of the NBOR Corporation. This software is designed to permit graphical means to be used for audio production. Instead of selecting commands from pull-down menus or the like, the method supports the operation of audio processes by these graphical means, which do not require or depend upon pull-down menus, task bars and associated icons.

These graphical means can be used to create sound switches, create digital signal processing (DSP) switches that cause DSP devices to be automatically created in the software, designate and assign signal paths, create links between audio sounds and DSP processes and controls, e.g., faders, create “composite” mixed sounds that are derived from sound sources and DSP applied to those sources, perform scrubbing and vari-speed operations on sounds, create independent signal paths for sounds and a main signal path, toggle between multiple sound inputs, multiple DSP processes, and between sound channels and their applied DSP processing, and a main channel and its applied DSP processing and more.

Although embodiments of the invention are described herein with respect to DSP switches and sound switches, the embodiments of the invention are not limited to these types of switches. The embodiments described herein can be generally applied to media switches that can control virtually anything in a computer environment, including sounds, devices, videos and graphics.

Embodiments of the invention are described herein with respect to a computer operating environment referred to as the “Blackspace” environment. However, the invention is not limited to the Blackspace environment and may be implemented in a different computer operating environment. The word “Blackspace” is a trademark of the NBOR Corporation. The Blackspace environment presents one universal drawing surface that is shared by all graphic objects within the environment. The Blackspace environment is analogous to a giant drawing “canvas” on which all graphic objects generated in the environment exist and can be applied. Thus, the Blackspace environment is sometimes referred to herein as the Blackspace surface. Each of these graphic objects can have a user-created relationship to any or all the other objects. There are no barriers between any of the objects that are created for or exist on this canvas.

The TEHO™ system utilizes the following graphic means for its operation and programming.
A. Creating DSP switches and sound switches by two means: (a) typing a key word or phrase on a graphical switch to program that switch to control a sound file or a DSP device, and (b) drawing an orange arrow with a designated “create object collection” arrow logic.
B. Associating graphic objects that represent sound files and/or DSP devices by drawing a graphic directional indicator, e.g., an arrow, that has an arrow logic associated with it.
C. Operating a “Show Switch” on a sound or DSP switch.
D. Operating Toggle switch.
E. Utilizing a “Save Me” switch, which automatically creates a “Combination switch” that consists of both one or more audio signals and one or more DSP processes.
F. Utilizing preprogrammed text controls that operate one or more DSP processes.
G. Operating user-defined Word controls that permit a user to control one or more DSP processes without requiring preprogrammed text controls.
H. Inputing one or more key words onto a switch or its equivalent to automatically create a function, process, operation, action or the like.
I. The utilization of context, either software embedded or user-defined, to modify the result of a drawn arrow and its associated arrow logic.

DSP Switches

One of the building blocks of the multi-media for this invention is DSP (Digital Signal Processing). Various types of this processing are available in the software. Each of these devices can be called forth by typing a known word on a switch and then activating that switch. Turning on the switch activates the device, e.g., makes it operational in a signal path. To send audio or video, etc., to and from these DSP switches, and therefore to the devices which they represent, arrows with arrow logics assigned to them are drawn from sound sources and video sources to various DSP devices. Also, the same arrows can be drawn from one or more DSP devices to one or more other DSP devices.

Below is a partial list of DSP devices that can be invoked by activating a DSP switch or by activating a text object that is programmed to call forth a DSP device.

Reverb. Various types of reverberation are available. To implement this, the word “Reverb”, “Rev” or the like is typed, drawn, spoken or otherwise input for a switch. Following such input, the user activates an alphanumeric key to enter this input to the software. This key could be the Enter key, Esc key or any other key that is designated for this purpose. It is also anticipated that a verbal command could be used to enter the input.

Delay. To implement this DSP, a user types “delay” on a blank switch or as text in the Blackspace environment and then hits the Esc key. If the user types “delay” in the Blackspace environment, the controls for this delay DSP device appear automatically. In other words, typing the words “delay” in the Blackspace environment and left-clicking (or its equivalent) on this text object will automatically cause the software to create the DSP device described by the typed text—in this case, a delay DSP device. The building of this device generally has two parts: (1) the actual DSP process that is created in software, and (2) the controls (knobs, faders, switches, etc.) that act as user controls for operating and modifying the DSP elements.

If a user types “delay” on a switch, the user can then right-click on that switch and the Info Canvas object for that switch will appear. “Info Canvas” is a trademark of the NBOR Corporation. For information on Info Canvas objects, see U.S. patent application Ser. No. 10/635,742, filed on Aug. 5, 2003, entitled “Intuitive Graphic User Interface with Universal Tools”, U.S. patent application Ser. No. 10/671,953, filed on Sep. 26, 2003, entitled “Intuitive Graphic User Interface with Universal Tools”, and PCT patent application no. PCT/US2004/025547, filed on Aug. 5, 2004, which are all incorporated herein by reference.

In this Info Canvas object is an entry called “Controls Hidden”. When this entry is green, the operational controls for the DSP device that is controlled by this switch are hidden. When this entry is the color gray, these DSP operational controls are visible.

When a user turns off “Controls Hidden”, this creates a “Show Switch” on the DSP switch. Then the user can turn on this Show Switch to see the DSP operational controls for the DSP device that is controlled by the DSP switch.

Step 1—Method 1

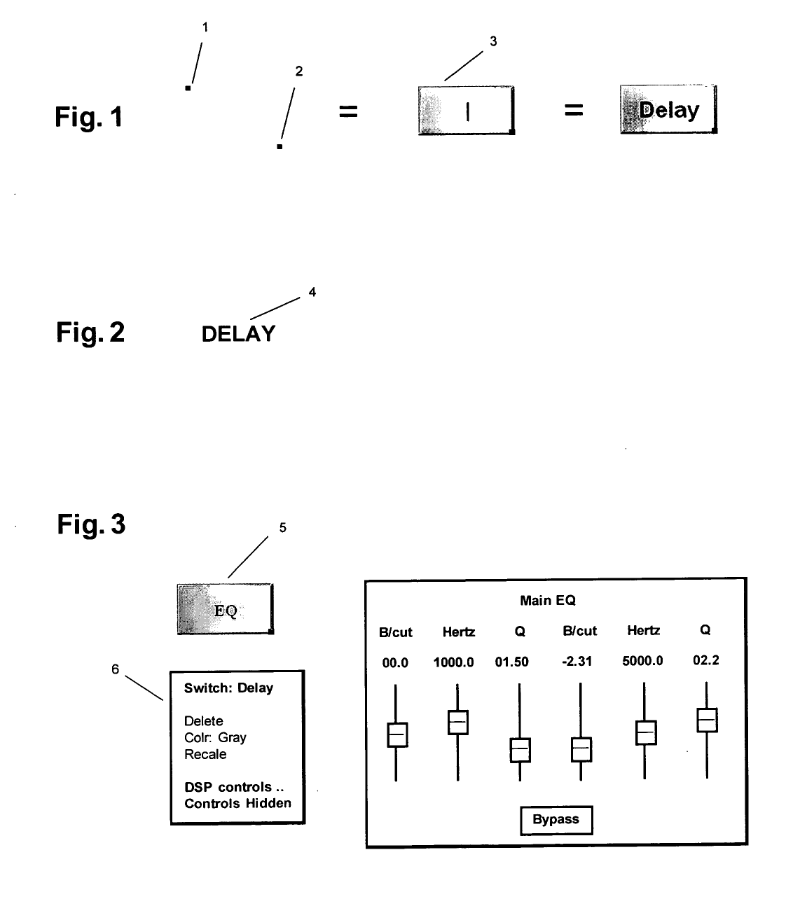

Referring to FIG. 1, a user left-clicks on two points 1 and 1, which are set apart by a minimal distance and angle, to create a switch. A switch 1 appears with a text cursor active on its surface. A user types the word “Delay” on this blank switch 3 and this programs the switch to become the control for a delay DSP device. When the switch 3 is activated, a DSP device for producing and altering delay is activated. Furthermore, the operational controls for this device can be made to temporarily appear onscreen, so the user knows that the controls have been successfully created.

The operation of a DSP switch is simple. When the switch is turned on, the DSP device is active. Furthermore, unless it is in the bypass mode, the DSP device is in the signal path and is processing the signal. If the DSP switch is turned off, it is removed from the signal path and is no longer processing the signal.

Step 1—Method 2

FIG. 2 illustrates step 1, method 2. A user types a key word “Delay” 4 onscreen and then left-clicks on this text. This activates the DSP process associated with this key word in software. Activating this text 4 causes the same result as activating a DSP switch. It turns on the DSP device associated with the text object, in this case, a delay DSP processor. When the text 4 is deactivated (e.g., by left-clicking on it again) the DSP device controlled by this text turns off.

Step 2:

A user right clicks on a DSP switch and the Info Canvas object for that switch appears. A user left-clicks (or its equivalent) on the entry “Controls Hidden” and the DSP controls toggle on (the entry Controls Hidden is gray off) and off (the entry Controls Hidden is green).

The controls below are shown or hidden dependent upon the entry Controls Hidden being on (hidden) or off (controls shown).

EQ (equalizer.) Typing the characters EQ on a switch and then touching the Esc key or its equivalent will cause an EQ DSP device to be created by the software. In operation, this works like the Delay DSP switch described above. In addition, any type of EQ DSP can be controlled by an EQ switch. The type of EQ that is built in software when an EQ switch is created can be set as a software default or be user-defined by making a selection of EQ types in an Info Canvas object or its equivalent.

In FIG. 3, the DSP switch “EQ” 5 has been right-clicked on to get an Info Canvas object 6 for that switch. In this Info Canvas object 6, the entry “Controls Hidden” has been turned on. This results in showing the operational controls for this DSP switch.

Compressor/limiter. A user types the word “Comp” or “C/L” on a switch to create this DSP device. Again the same operational procedure applies here as described for the Delay and EQ DSP switches above.

Pan. Type the word “Pan” onscreen and hit Esc or type the word “Pan” on a switch and hit Esc. Either approach causes a pan DSP device to be created in software.

Other types of DSP devices can be created by the above-described methods. These can include: spatializers, auto panners, flangers, phasers, de-essers, room equalizers, spectrum analyzers, and more.

A basic building block for the TEHO system is switches. There are various types of switches that support the TEHO system. They are: sound switches, DSP switches, “Save Me” switches, “Combination” switches, and operational switches, e.g., mode switches.

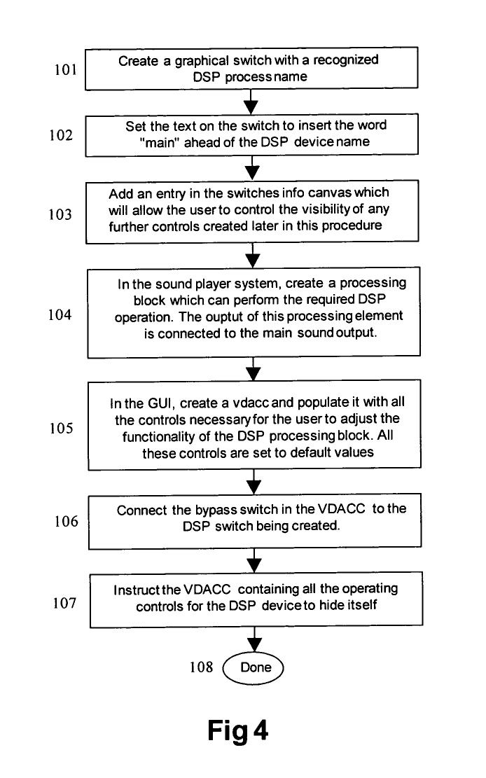

FIG. 4 is a flowchart describing the creation of a DSP switch in accordance with an embodiment of the invention. A DSP switch is a graphical switch which is associated with a sound processing element in a sound record/playback system. When the switch is ON, the DSP element is active. When the switch is OFF, the DSP process is deactivated or bypassed and performs no operations on any incoming audio signal.

Referring to block 101, when the user creates a switch in the GUI, the user can immediately type a name onto the switch surface. If the sound system recognizes this name as the name of a DSP process, such as delay, eq, reverb, etc., then this procedure is invoked to add the appropriate functionality to the switch.

Block 102. The word “Main” is added to the switch text to indicate that the DSP device is allocated to the main sound output channel until it is re-assigned in the signal processing chain by other user actions.

Block 103. The software adds a dynamic entry into the Info Canvas object for the DSP switch that allows the user to determine whether the DSP controls are visible onscreen or remain invisible.

Block 104. In the sound player software a processing block is created that can perform the required DSP operation as defined by the DSP switch. The output of this processing block (element) is connected to the main sound output.

Block 105. In the GUI the software create a VDACC object and in this VDACC object are placed all of the controls necessary to operate the DSP device controlled by the DSP switch. All of these DSP controls are set to default values, but they can be changed at any time by the user.

A VDACC object includes a workspace surface or canvas that may be larger than the visible or viewable area of the VDACC object. Thus, a VDACC object allows a user to scroll the visible area to view graphic objects or contents in the VDACC object that were hidden from the visible area. For more information on VDACC objects, see U.S. patent application Ser. No. 10/635,742, filed on Aug. 5, 2003, entitled “Intuitive Graphic User Interface with Universal Tools”, U.S. patent application Ser. No. 10/671,953, filed on Sep. 26, 2003, entitled “Intuitive Graphic User Interface with Universal Tools”, and PCT patent application no. PCT/US2004/025547, filed on Aug. 5, 2004.

A DSP device will have a number of parameters which can usefully be adjusted by the user, e.g., delay time in a delay process or high frequency boost in an equalizer. A collection of faders, knobs, switches, labels and other graphic devices can be placed into the VDACC object to control and display the state of all these parameters.

Block 106. The software connects a bypass switch in the VDACC object to the DSP switch that is being created.

All DSP devices have one feature in common. The ability to be bypassed, or switched off. When they are switched off, no processing of the audio signal is performed and the input signal is passed unmodified directly to the output. If the VDACC object contains a bypass switch to achieve this functionality, it is connected to the main DSP switch which is being created in this flowchart. When the DSP switch is turned ON, the bypass switch is automatically turned OFF, and vice versa.

Block 107. The software instructs the VDACC object, which contains all of the controls for operating the DSP device, to hide itself—become invisible.

Block 108. The process ends.

Sound Switches

Entire signal paths including sound sources and DSP devices can be created by drawing and labeling various switches and typing a valid sound file (sound source) name and/or DSP device (DSP function) on each of them. To accomplish this, a user creates a switch and then types a key word or phrase on it. If this key word equals the name of a sound file that is known to the software, then this results in the creation of a valid sound switch. This sound switch has various benefits.

First, as a switch, it can be turned on or off. Therefore a sound switch immediately provides the benefit of enabling a user to mute the sound source at any time or the inverse of this, solo one or more sound sources at any time. To mute a sound switch, a user touches it so that it turns off. To solo a sound switch, the user would turn off all other sound switches except the one or more sound switches that they wish to solo—leave on.

Second, arrows and their associated arrow logics can be drawn to and from sound switches to apply control to the sounds that these sound switches control. Furthermore, such arrows can be drawn from one or more sound switches to one or more DSP switches to cause the sound to be passed into or out of one or more DSP devices.

Third, sound switches can be dragged to a timeline to cause a play bar for the sound that is represented by that sound switch to appear. This play bar enables a user to edit the sound controlled by that sound switch. Such editing would include altering the positing in time that the sound plays, altering the length of the sound, removing or adding a section of sound from in the interior portion of the sound. For a discussion of timelines and their use with media development, please refer to U.S. patent application Ser. No. 10/672,391, filed Sep. 26, 2003, entitled “System and Method of Recording and Replaying Property Changes on Graphic Elements in a Computer Environment”, which incorporated herein by reference.

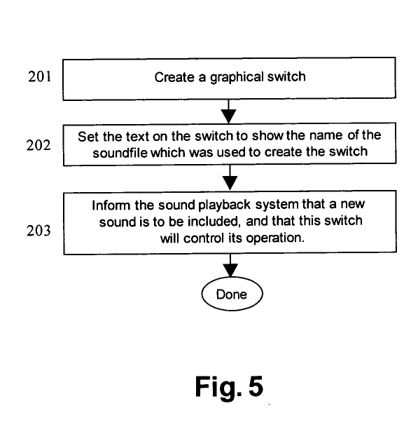

FIG. 5 is a flowchart describing the creation of a sound switch in accordance with an embodiment of the invention. A sound switch is a graphical switch, which is associated with a sound file. When the switch is “on”, the sound file can be replayed by the sound playback system. When the switch is “off”, the sound file is not reproduced when the sound system is in playback mode.

Block 201. The user creates a graphical switch or it is created automatically by the software, e.g., as part of a default load process or as part of the orange arrow process.

Block 202. A name of a sound file is input for the switch. One method of accomplishing this is to type the name of the sound file onto the switch. Another method would be to verbally input the name of this sound file after first selecting the switch. Other methods of input are possible.

Block 203. The software then informs the playback system that a new sound file has been recalled and this switch will control its operation.

Block 204. The process ends.

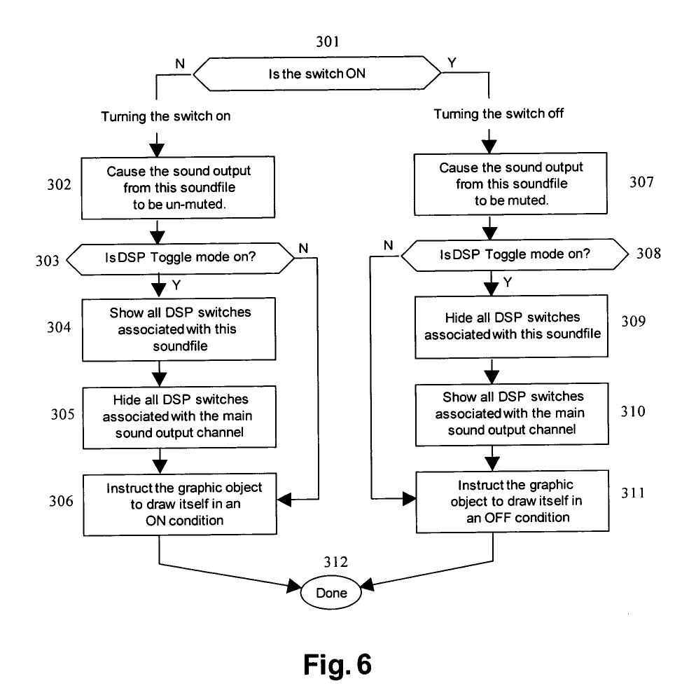

FIG. 6 is a flowchart describing the activation of a sound switch in accordance with an embodiment of the invention.

Block 301. The on/off status of the sound switch is determined.

If status is “off,” the sound switch is then turned on.

Block 302. The output of the sound file, for which this switch represents and controls, is un-muted. The user would likely see the switch's status change. For instance, an un-muted sound switch could appear to be unpressed or its color could change from gray (muted) to green (un-muted).

Block 303. The software checks to see if the DSP “Toggle” mode is on. If a sound switch is not part of the TEHO system, then this step can be bypassed.

Block 304. If yes, then all DSP switches that are associated with this sound file are shown onscreen. DSP switches can be associated with a sound switch for various reasons. Two reasons are:
(a) The sound switches sound file can be sent to one or more DSP devices that are controlled by one or more DSP switches.
(b) The sound switches sound file can be the input to an audio channel where the DSP devices controlled by one or more DSP switches can be the processing for that audio channel.

Block 305. All DSP switches that are associated with the main sound output channel are hidden and in their place all DSP switches that are associated with the sound switch remain onscreen. This lets the user gain easy access to the DSP processing for the sound file that is represented by the sound switch. It also provides the user with an easy toggle action to show either the DSP processes for one or more sound switches or the DSP processes for the main sound output channel. The main sound output channel can be like the master output on a recording console. As such, it would serve the purpose of being the final processing and mixing channel for an audio console, as supported in the TEHO system.

Block 306. The software instructs the sound switch to change its appearance to show an “on” status for the switch. This could be shown by changing the color of the switch from gray (off) to green (on) or the switch could go from being undepressed (off) to being depressed (on) or the like.

Now Referring to the Right Side of the Flowchart, the User Turns Off the Sound Switch.

Block 307. The output of the sound file, for which this switch represents and controls, is muted. The user would likely see the switch's status change.

Block 308. The software checks to see if the DSP “Toggle” mode is on.

Block 309. If yes, then all DSP switches that are associated with this sound file are hidden.

Block 310. All DSP switches that are associated with the main sound output channel are shown.

Block 311. The software instructs the sound switch to change its appearance to show an “off” status for the switch.

Referring again to Block 303, if no, then the software goes to Block 306.

Referring again to Block 308, if no, then the software goes to Block 311.

Block 312. The process ends.

The Use of Arrows and their Associated Arrow Logics

Graphic directional indicators, e.g., arrows, are a key graphic means for programming the objects of the TEHO system. The system provides for the use of such arrows that have arrow logics associated with them to create a variety of operations for the TEHO system.

Various types of arrow logics are used. In part, they include the following:

A red “control” arrow logic: This logic can be stated by the following sentence: “the object that the arrow intersects at its tail controls the object that the arrow intersects at it arrowhead.”

NOTE: for all listed arrow logics, the resulting action from the implementation of the arrow logic is controlled not only by the combination of the arrow logic itself and the source and target object(s) for that arrow, but also by various contexts. These ways and means that these contexts can modify arrow logics are discussed later.

Common uses of the red control logic are:
(a) To permit a fader to control some property of a sound switch, DSP switch combination switch or the like.
(b) To permit a switch to control other switches in the system.

A gray “send to” arrow logic: This logic can be stated by the following sentence: “the object(s) that the arrow intersects at its tail are sent to the input of the object that is intersected by the arrow's arrowhead.”

Common uses of the gray “send to” arrow are:
(a) Define a signal path between DSP devices.
(b) Define a signal path between sounds and DSP devices.
(c) Send multiple sounds to a single input.

An orange “create object collection” arrow logic: This logic can be stated by the following sentence: “The items that the arrow is drawn from, encircles, intersects, or nearly intersects (“intersects”) are turned into switches or switchable thumbnails in a VDACC object when the arrow is pointed to a blank Blackspace region.”

The orange arrow can cause different types of results when it is used to intersect different types of media files. For instance, if the orange arrow, and its associated arrow logic, is used to intersect one or more sound files, these sound files are used to create sound switches—one switch for each sound file name that is intersected by the orange arrow. If the orange arrow is used to intersect one or more DSP files, these DSP files are used to create DSP switches—one switch for each DSP file name that is intersected by the orange arrow. If the orange arrow is used to intersect one or more picture files, these picture files are used to create switchable thumbnails.

The basic operation of the orange arrow is that the switches and thumbnails it creates are placed into a VDACC object. This operation can be changed by a user so that the switches that are created are simply placed on screen space. This change of operation can be affected by a user selecting an entry in the Info Canvas object for the orange arrow after its arrowhead has turned white—after the software has recognized the drawing of the orange arrow as producing a valid arrow logic.

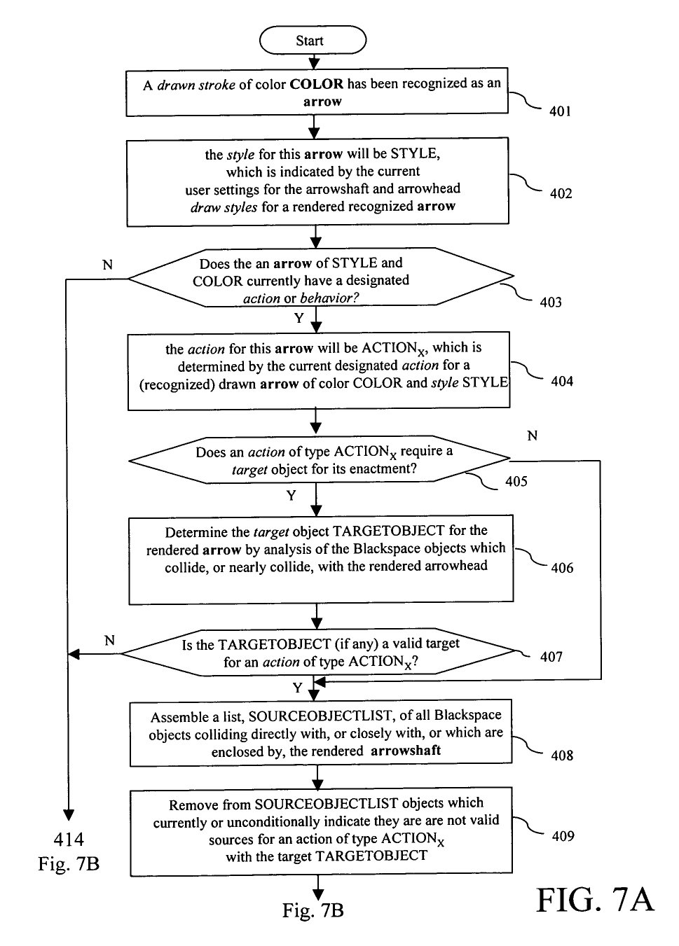

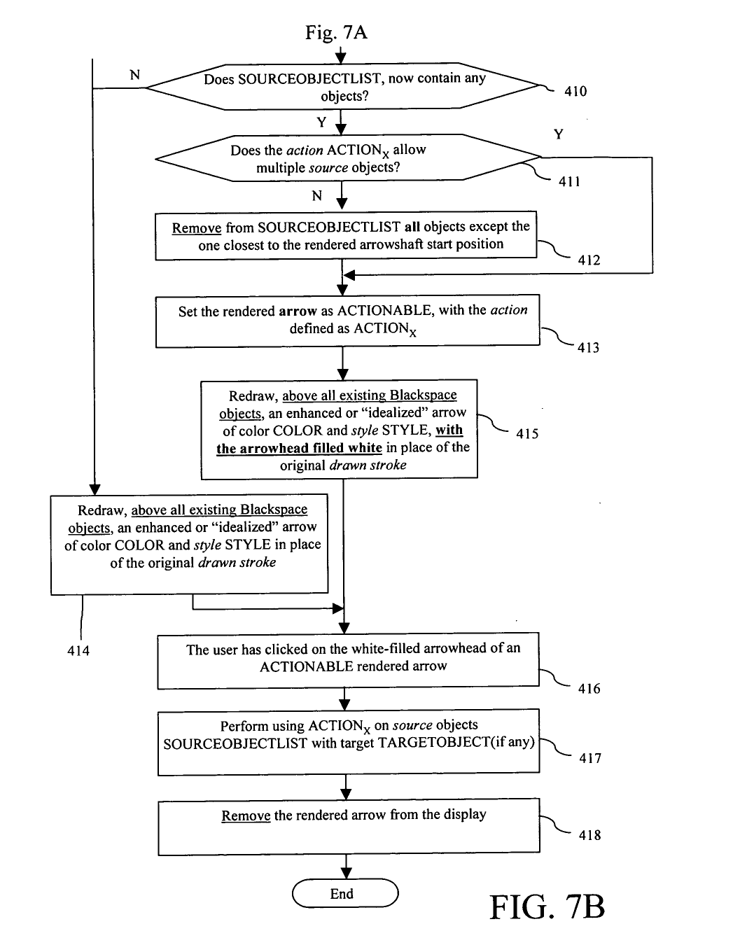

With reference to the flowchart of FIGS. 7A and 7B, the process for drawing an arrow in Blackspace environment and applying an arrow logic in accordance with an embodiment of the invention is now described.

Block 401. A drawn stroke of color “COLOR” has been recognized as an arrow—a mouse down has occurred, a drawn stroke (one or more mouse movements) has occurred, and a mouse up has occurred. This stroke is of a user-chosen color. The color is one of the factors that determine the action (“arrow logic”) of the arrow. In other words, a red arrow can have one type of action (behavior) and a yellow arrow can have another type of action (behavior) assigned to it.

Block 402. The style for this arrow will be “STYLE”—This is a user-defined parameter for the type of line used to draw the arrow. Types include: dashed, dotted, slotted, shaded, 3D, etc.

Block 403. Does an arrow of STYLE and COLOR currently have a designated action or behavior? This is a test to see if an arrow logic has been created for a given color and/or line style. The software searches for a match to the style and color of the drawn arrow to determine if a behavior can be found that has been designated for that color and/or line style. This designation can be a software default or a user-defined parameter.

If the answer to Block 403 is yes, the process proceeds to Block 404. If no, the process proceeds to Block 404.

Block 404. The action for this arrow will be ACTION_{X}, which is determined by the current designated action for a recognized drawn arrow of COLOR and STYLE. If the arrow of STYLE and COLOR does currently have a designated action or behavior, namely, there is an action for this arrow, then the software looks up the available actions and determines that such an action exists (is provided for in the software) for this color and/or style of line when used to draw a recognized arrow. In this step the action of this arrow is determined.

Block 405. Does an action of type ACTION_{X} require a target object for its enactment? The arrow logic for any valid recognized arrow includes as part of the logic a determination of the type(s) and quantities of objects that the arrow logic can be applied to after the recognition of the drawn arrow. This determination of type(s) and quantities of objects is a context for the drawn arrow, which is recognized by the software.

### EXAMPLE 1

Let's say a red arrow is drawn between four (4) faders such that the arrow intersects all four faders. Let's further say the red arrow logic is a “control logic,” namely, the arrow permits the object that it's drawn from to control the object that it's drawn to. Therefore, with this arrow logic of the red arrow, a target is required. Furthermore, the first intersected fader will control the last intersected fader and the faders in between will be ignored. See Blocks 411 and 412 in this flowchart.

### EXAMPLE 2

Let's say a yellow arrow is drawn between four faders, such that the arrow shaft intersects the first three faders and the tip of the arrow intersects the fourth fader. Let's further say that an “assignment” arrow logic is designated for the color yellow, namely, “every object that the arrow intersects will be assigned to the object that arrow points to.” In this case, the arrow logic will be invalid, as a fader cannot be assigned to another fader according to this logic. Whereas, if the same yellow arrow is drawn to intersect four faders and the arrowhead is made to intersect a blue star, the four faders will be assigned to the star.

The behavior of the blue star will be governed by the yellow arrow logic. In this instance, the four faders will disappear from the screen and, from this point on, have their screen presence be determined by the status of the blue star. In other words, they will reappear in their same positions when the blue star is clicked on and then disappear again when the blue star is clicked once more and so on. Furthermore, the behavior of the faders will not be altered by their assignment to the blue star. They still exist on the Global drawing surface as they did before with their same properties and functionality, but they can be hidden by clicking on the blue star to which they have been assigned. Finally, they can be moved to any new location while they are visible and their assignment to the blue star remains intact.

### EXAMPLE 3

Let's say you draw a green arrow which has a “copy” logic assigned to it, which states, “copy the object(s) that the arrow shaft intersects or encircled to the point on the Global Drawing surface (Blackspace) that the tip of the arrowhead points to”. Because of the nature of this arrow logic, no target object is required. What will happen is that the object(s) intersected or encircled by the green arrow will be copied to another location on the Global Drawing surface.

If the answer to Block 405 is yes, the process proceeds to Block 406. If no, the process proceeds to Block 408.

Block 406. Determine the target object TARGETOBJECT for the rendered arrow by analysis of the Blackspace objects which collide or nearly collide with the rendered arrowhead. The software looks at the position of the arrowhead on the global drawing surface and determines which objects, if any, collide with it. The determination of a collision can be set in the software to require an actual intersection or distance from the tip of the arrowhead to the edge of an object that is deemed to be a collision. Furthermore, if no directly colliding objects are found, preference may or not be given to objects which do not collide in close proximity, but which are near to the arrowhead, and are more closely aligned to the direction of the arrowhead than other surrounding objects. In other words, objects which are situated on the axis of the arrowhead may be chosen as targets even though they don't meet a strict “collision” requirement. In all cases, if there is potential conflict as to which object to designate as the target, the object with the highest object layer will be designated. The object with the highest layer is defined as the object that can overlap and overdraw other objects that it intersects.

Block 407. Is the target object (if any) a valid target for an action of the type ACTION_{X}? This step determines if the target object(s) can have the arrow logic (that belongs to the line which has been drawn as an arrow and recognized as such by the software) applied to it. Certain arrow logics require certain types of targets. As mentioned above, a “copy” logic (green arrow) does not require a target. A “control” logic (red arrow) recognizes only the object to which the tip of the arrow is intersecting or nearly intersecting as its target.

If the answer to Block 407 is yes, the process proceeds to Block 408. If no, the process proceeds to Block 410.

Block 408. Assemble a list, SOURCEOBJECTLIST, of all Blackspace objects colliding directly with, or closely with, or which are enclosed by, the rendered arrowshaft. This list includes all objects as they exist on the global drawing surface that are intersected or encircled by or nearly intersected by the drawn and recognized arrow object. They are placed in a list in memory, called for example, the “source object list” for this recognized and rendered arrow.

Block 409. Remove from SOURCEOBJECTLIST, objects which currently or unconditionally indicate they are not valid sources for an action of type ACTION_{X} with the target TARGETOBJECT. Different arrow logics have different conditions in which they recognize objects that they determine as being valid sources for their arrow logic. The software analyzes all source objects on this list and then evaluates each listed object according to the implementation of the arrow logic to these sources and to the target(s), if any. All source objects which are not valid sources for a given arrow logic, which has been drawn between that object and a target object, will be removed from this list.

Block 410. Does SOURCEOBJECTLIST now contain any objects? If any source objects qualify as being valid for the type of arrow logic belonging to the drawn and recognized arrow that intersected or nearly intersected them, and such logic is valid for the type of target object(s) intersected by this arrow, then these source objects will remain in the sourceobjectlist.

If the answer to Block 410 is yes, the process proceeds to Block 411. If no, the process proceeds to Block 414.

Block 411. Does the action “ACTION_{X}” allow multiple source objects? A test is done to query the type of arrow logic belonging to the drawn and recognized arrow to determine if the action of its arrow logic permits multiple source objects to be intersected or nearly intersected by its shaft.

If the answer to Block 411 is yes, the process proceeds to Block 413. If no, the process proceeds to Block 412.

Block 412. Remove from SOURCEOBJECTLIST all objects except the one closest to the rendered arrowshaft start position. In this case, the recognized arrow logic can have only a single source. So the software determines that the colliding object which is closest to the drawn and recognized arrow's start position is the source object and then removes all other source objects that collide with its shaft.

NOTE: Certain types of arrow logics require certain types of sources. For instance, if a red “control” arrow is drawn to intersect four switches and then drawn to point to blank Blackspace surface (an area on the global drawing surface where no objects exist), then no valid sources will exist and no arrow logic will be applied. The “red” logic will be considered invalid. It's invalid because although the source objects are correct for this type of arrow logic, a suitable target object must exist for the “control” logic to be valid in the absence of a context that would override this requirement. If however, this same red arrow is drawn to intersect these same four switches and then the tip of the arrow also intersects or nearly intersects a fifth switch (a valid target for this logic), then the red arrow logic recognizes the first intersected switch only as its source and the last intersected switch only as the target. The other intersected switches that appeared on the “sourceobjectlist” will be removed.

Block 413. Set the rendered arrow as Actionable with the action defined as ACTION_{X}. After Block 412, the required action has been identified and has not been immediately implemented because it awaits an input from a user. As an example, identifying the action would be to have the arrowhead of the drawn and recognized arrow turn white (see Block 415). An example of input from a user would be requiring them to click on the white arrowhead to activate the logic of the drawn and recognized arrow (see Blocks 415-418).

Block 414. Redraw above all existing Blackspace objects an enhanced or “idealized” arrow of COLOR and STYLE in place of the original drawn stroke. If an arrow logic is not deemed to be valid for any reason, the drawn arrow is still recognized, but rendered onscreen as a graphic object only. The rendering of this arrow object includes the redrawing of it by the software in an idealized form as a computer generated arrow with a shaft and arrow head equaling the color and line style that were used to draw the arrow.

Block 415. Redraw above all existing Blackspace objects, an enhanced or “idealized” arrow of COLOR and STYLE with the arrowhead filled white in place of the original drawn stroke. After the arrow logic is deemed to be valid for both its source(s) and target object(s), then the arrowhead of the drawn and recognized arrow will turn white. This lets a user decide if they wish to complete the implementation of the arrow logic for the currently designated source object(s) and target object(s).

Block 416. The user has clicked on the white-filled arrowhead of an Actionable rendered arrow. The user places their mouse cursor over the white arrowhead of the drawn and recognized arrow and then performs a mouse downclick.

Block 417. Perform using ACTION_{X} on source objects “SOURCEOBJECTLIST” with target “TARGETOBJECT” if any. After receiving a mouse downclick on the white arrowhead, the software performs the action of the arrow logic on the source object(s) and the target object(s) as defined by the arrow logic.

Block 418. Remove the rendered arrow from the display. After the arrow logic is performed under Block 417, the arrow is removed from being onscreen and no longer appears on the global drawing surface. This removal is not graphical only. The arrow is removed and no longer exists in time. However, the result of its action being performed on its source and target object(s) remains.

The Use of Context for Arrow Logics

Arrow logics can be modifiable by one or more contexts. A context can include a combination of graphic elements and their associated properties, behaviors, actions, functions, operations, and the like. It can also include the presence of a drawn and recognized arrow that has an associated arrow logic and which intersects one or more graphic objects. Contexts can be widely varied and virtually infinite in their possibilities.

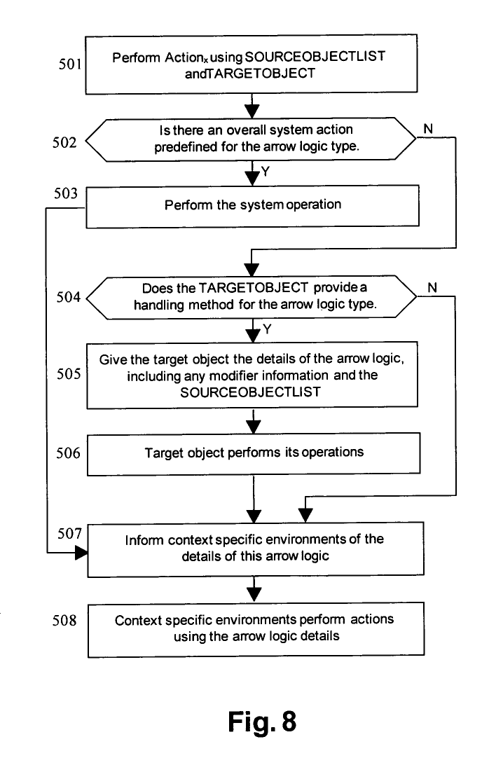

FIG. 8 is a flowchart describing the use of contexts with an arrow logic in accordance with an embodiment of the invention. This flowchart illustrates the way that specific contexts can add functionality to arrow logics. The generic arrow logic says to perform an action given a source and target object list. This information can also be notified to specific contexts which are sub-systems of the Blackspace environment. These contexts can be used or referenced to modify the result of the arrow logic that is being implemented.

Block 501. This “perform Action X” is a software operation, which is determined by all of the conditions detected by when the arrow logic was constructed. In other words, when an arrow with a designated arrow logic was drawn and recognized and that arrow logic is found to be valid.

The number of possible actions provided for in this flowchart is very large and beyond the scope of this flowchart. However some general procedures are outlined here.

Block 502. In order to perform Action X, the software needs to determine what this action is. As part of this process, the software checks to make sure that the drawn and recognized arrow has an arrow logic designated for it.

Block 503. An example of a system operation might be to set up a “tween” operation between the objects intersected by the arrow, or create a slideshow from the intersected objects. The system operation with regards to an arrow logic is at least in part dependent upon the type of arrow logic itself and the manner in which the arrow, which has that arrow logic designated for it, has been drawn. However, in many cases, the system operation may not be dependent purely upon the arrow intersecting source and target object(s).

Block 504. The term “handling method” means some software operation that implements the particular arrow logic that has been detected. In this step, the software checks to see if such an operation exits in the target object. Some arrow logics require a target object to provide the functionality required to implement the arrow logic.

The general behavior of arrow flowchart (uses perform Action X). This should have said in the target object.

Action X can be many things. In some arrow logics, it may not use a target object at all. This is the case with a blue “sequence” arrow logic. The arrowhead must point to blank space (intersecting no target object) in order for this logic to be valid. In other arrow logics, they must have a target object to be implemented. Some arrow logics can be valid when then have a target object and when they don't. Let's take a red control arrow logic. The basic red control arrow logic requires a target object.

For instance, if a red arrow is drawn from a fader to another fader, the first fader will control the second fader's values. If however, a red control arrow is drawn from an inkwell color and it pointed to blank Blackspace surface, the background color of Blackspace surface can be changed to the color of the source object (namely the color square that was intersected by the tail of this drawn red arrow).

What enables the arrow logic to be valid or not valid or to have one type of result in one case and another type of result in another case is “context.”

Continuing with a discussion of Block 504, when an arrow that has a designated arrow logic is drawn and recognized, the arrow logic software calls a method entitled: “process arrow logic” for the target object of this drawn arrow. This method exists in the target object. This method is present in most of the objects in the Blackspace environment. All objects in this software consist of properties and methods. One method that is common to most objects in the Blackspace environment is the ability to process an arrow logic.

When a recognized arrow, that has a designated arrow logic, is drawn to intersect a target object, this method (the ability to process an arrow logic by an object) is invoked. Let's say the arrow logic is “place inside” and the target object is a blue star. Then the software that's in the blue star object says: ‘this is a “place inside’ logic and I'm going to create a Container and place all of the source objects for the drawn and recognized arrow (for which I am the target object) in it and attach this assignment to myself.

There may be other arrow logics that this blue star may be able to respond to when it gets the command from the arrow logic software and this response may cause a different result. For instance, let's say that a red arrow is drawn intersecting a fader object at its tail and the blue star at its tip. Again, the blue star is the target for this arrow. If the shaft of this red arrow were intersected by a modifier arrow where the word “color” were typed for this modifier, then this is a valid arrow logic for the target blue star.

However, the blue star now says: “This is a “control logic with a modifer ‘color’.” The software that is implementing the processing of the arrow logic (the software in the blue star) sets up a permanent connection between the source object and itself where the changes in the source object will adjust the color of the target object, namely the blue star. In this case, when the fader (the source object) has its value changed by moving its fader cap to a new position, the color of the target object (the blue star) is changed accordingly.

Block 505. When the method is invoked in the target object, the arrow logic information is passed to the target object so the target object can decide if it can process that information.

Block 506. The arrow logic type and modifier information is used by the target object to execute specific functionality for itself.

Block 507. An example of a context specific environment might be a sound reproduction/recording system. When this subsystem is informed of the arrow logic, it can perform its own operations based on the TARGETOBJECT, SOURCEOBJECTLIST and modifier information. Sub-systems like this may have a wide variety of capabilities, which can be operated and controlled using arrow logics in the GUI.

Block 508. Context specific environments can also perform many and varied operations using arrow logics. A sound system would be such an environment. These operations may involve making decisions which could not be completely analyzed in the GUI. Operations in specific contexts could involve interpreting the usage of all or some of the objects in the SOURCELIST in ways which might treat them as targets and interpreting the target object as a SOURCE. By way of illustration some possible operations for a sound processing system can be shown.

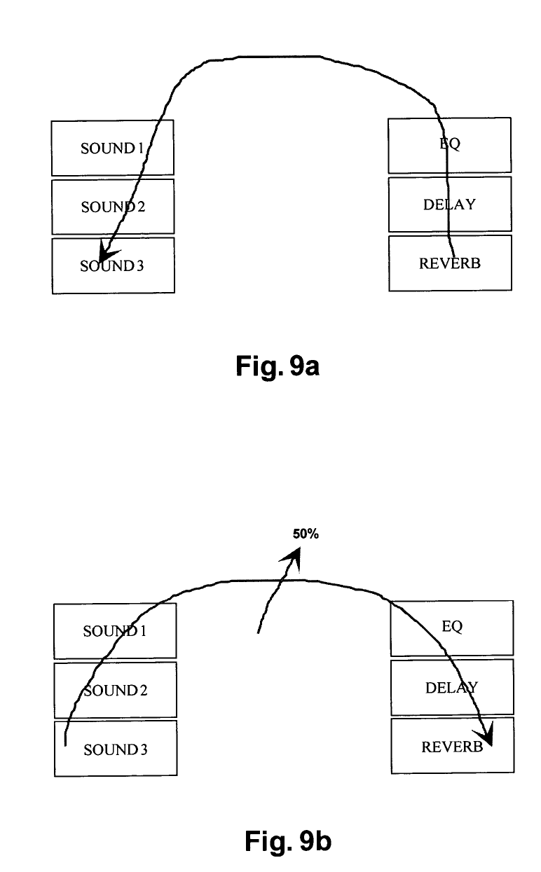

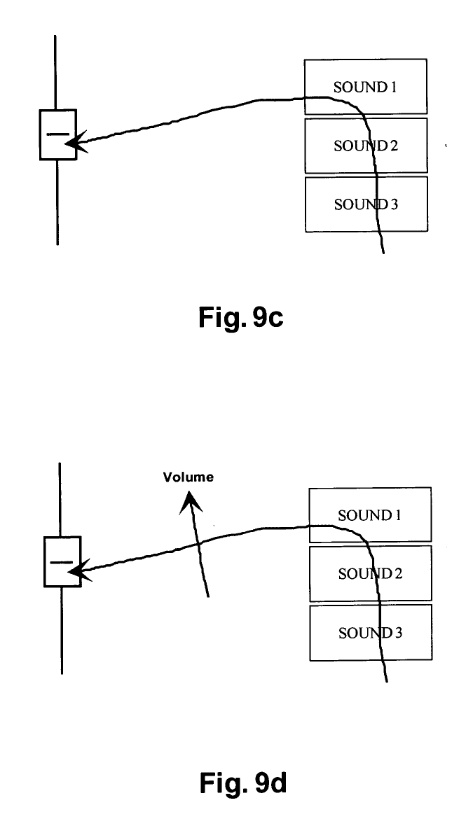

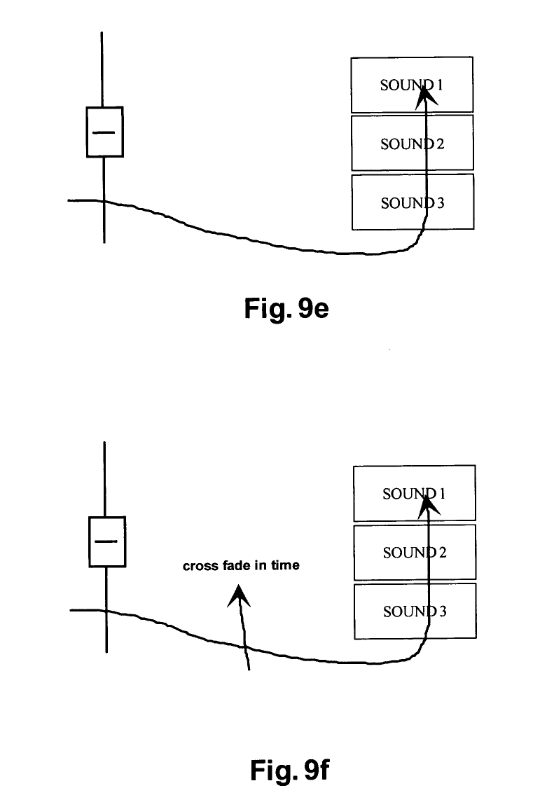

FIG. 9a shows an arrow logic where the target object represents a sound source and the source object list contains objects representing both other sound sources and sound processing elements, e.g., DSP switches. For instance, if the arrow logic type was “send to”, this could be interpreted as an instruction to apply the sound processing elements in the source list not just to the target object, but also to any other objects in the source list that are also sound sources.

In this diagram is shown a gray arrow with a “send to” arrow logic designated for it. It is drawn where its tail intersects three DSP switches which become entered into its SOURCE OBJECT LIST. Also, it intersects three sound switches. The last sound switch only is entered into its TARGET OBJECT LIST, as this is the object that the arrow's tip is intersecting. The other two sound switches are entered into the SOURCE OBJECT LIST for this arrow.

Because the target object is a sound switch, then any other sound switches in the source list are treated as targets for this drawn and recognized arrow. How does the software know to do this? The answer is that the interpretation of the arrow logic by the sound system uses a context to define this interpretation. In this case the context is the combination of a drawn and recognized gray “send to” arrow, the intersecting of multiple DSP and sound switches by this drawn arrow, plus the fact that the arrow's tip intersects a sound switch and its tail intersects DSP switches. Here, this context tells the sound system's interpretation of the arrow logic software how it should interpret a drawn “send to” arrow.

In this case, a possible operation is as follows: each of the DSP devices that is controlled by each of the DSP switches is added as a signal processor to each channel containing each sound file that is controlled by each of the sound switches. In other words, each sound switch controls a sound file input into its own channel. Therefore, each of these audio channels will now have its own EQ, Delay and Reverb processors.

There are two ways of this overall operation being implemented.
(1) The arrow logic is analyzed when it's received by the sound sub-system and it tests for what the target object is and the contents of the source list and if this particular combination exists it moves the sound sources into the target list.
(2) The user can create a “Save Context switch” and then draw a red arrow that encircles and/or intersects all of the elements shown in the figure above, where the arrow's tip points to the switch. Upon activating this arrow, this group of graphic elements is saved as a context. This context can then be used as described under (1) directly above. This method is described in U.S. patent application Ser. No. ______, filed Sep. 13, 2004, entitled “Method for Creating User-Defined Computer Operations Using Arrows”, which is incorporated herein by reference.

FIG. 9b shows an arrow logic where the target object represents a sound processing element and the source object list contains objects representing both sound sources and other sound processing elements. If the arrow logic type was “send to”, this could be interpreted as an instruction to send the signals from all the sound sources in the source list to a signal processing chain constructed from all the processing elements in the source list. This processing chain would be constructed in the order that the objects were listed in the source list and culminating in the target processing element. A modifier in this logic may be used to further alter the signal applied to this processing chain, for example, by specifying that the combined inputs to the processing chain may be adjusted by a gain factor if the modifier text could be interpreted as a fractional number such as “50%” or “1.5.”

In this diagram is shown a gray arrow with a “send to” arrow logic designated for it. It is drawn where its tail intersects three sound switches which become entered into its SOURCE OBJECT LIST. Also, it intersects three DSP switches. The last DSP switch only is entered into its TARGET OBJECT LIST, as this is the object that the arrow's tip is intersecting. The other two DSP switches are entered into the SOURCE OBJECT LIST for this arrow.

Because the target object is a DSP switch, then any other DSP switches in the source list are treated as targets for this drawn and recognized arrow. The software utilizes a new context to perform its operations in this example. In this case the context is the combination of a drawn and recognized gray “send to” arrow, the intersecting of multiple sound and DSP switches by this drawn arrow, and the fact that the arrow's tip intersects a DSP switch and its tail intersects sound switches. In this case, this context tells the sound system's interpretation of the arrow logic software how it should interpret a drawn “send to” arrow.

In this case, a possible operation is as follows: each of the sound files that is controlled by each of the sound switches is summed and sent to the audio channel containing the DSP devices, namely, EQ, Delay and Reverb.

FIG. 9c shows an arrow logic where the target object is a control device such as a fader, and the source list contains a number of objects representing sound sources. If the arrow logic type was “control from” then this could be interpreted as an instruction to apply the control from the fader to the signal level for all the sounds in the source list.

FIG. 9d shows modifier text being used to dictate which feature of the sound sources should be controlled by the fader.

Sound sources could have a number of features such as volume, start time and end time. Modifier text is the modifier information in the arrow logic supplied from the GUI. The modifier text is what you type for a modifier arrow. See U.S. patent application Ser. No. ______, filed Sep. 13, 2004, entitled “Method for Creating User-Defined Computer Operations Using Arrows”.

The drawing of the control arrow can have a preset modifier defined for it in the software. Or the user can define this modifier or replace a predefined modifier by drawing his/her own modifier arrow which intersects the shaft of the first drawn arrow and the user can then type a modifier text for that modifier arrow. For more information, see U.S. patent application Ser. No. ______, filed Sep. 13, 2004, entitled “Method for Creating User-Defined Computer Operations Using Arrows”.

FIG. 9e shows an arrow logic where the target object represents a sound source and the source object list contains objects representing both other sound sources and a controlling device such as a fader. If the arrow logic type was “control from” then this could be interpreted as an instruction to apply the control from the fader, in the source object list, to the signal level for all the sounds in the source list as well as the target object. The fader, of course, is excluded for this inclusion as it is not a sound.

FIG. 9f shows modifier text could be used to dictate which feature of the sound sources should be controlled by the fader. In the case of the example below, a modifier arrow has been drawn to intersect the first drawn arrow and the modifier text “cross fade in time” has been added. The software is programmed to be able to interpret various words and phrases as key words that can be input by a user to cause various actions. In this case when the arrow logic with its modifier is activated, the changes in the fader's value will cause a change in the cross fade in time for each of the sounds in the source object list for the first drawn arrow.

Assigning a Fader to Control Sound Switches

A single fader can be used to control the independent volume of one or more sound switches. To accomplish this, the following steps are required.
A. A fader object is drawn by a user and recognized by the software.
B. A red control arrow (a red arrow with a “control” logic associate with it) is drawn such that it intersects the sound switches and then points to the fader. Once the software recognizes this drawing as a valid context for the drawing of this arrow, the arrowhead for the arrow turns white or its equivalent.
C. To implement the control arrow logic, the user left-clicks on the white arrowhead of the drawn and recognized arrow. This causes the word “Volume” to appear at the top of the fader. This also causes links to be created whereby this single fader can now act as an individual volume control for each of the sound files controlled by each of the sound switches.

Using this single fader, a user can make independent volume adjustments for each of the sound switches that are controlled by the fader. Making an adjustment in this fader's value changes the volume of the sound controlled by the currently selected sound switch. A sound switch is selected by touching it. When touched, it can change it appearance to indicate that has been selected.

The ability exists to independently interrogate this fader's volume setting for each sound that it is controlling the volume of. This is accomplished by left-clicking on each of the sound switches. This action causes the fader's cap to move automatically to show the fader's volume setting for that individual sound switch.

In addition, there needs to exist a method that enables a user to know which sound switch this fader is controlling at a particular point in time. In other words, if a user moves the fader cap for this fader, which in turn will result in a volume adjustment for one of the sound switches that it is linked to, which of the sound switches controlled by this fader will be affected?

One solution to this problem is to cause the software to operate in this manner: The volume fader, as described above, controls the volume for the last sound switch that was made active (that was turned on). This is an important point, because one can have multiple sound switches on at the same time, but the fader that is linked to them can only be used to adjust the volume of one of them at a time.

Even though this fader must be used to make one adjustment at a time, at all times this single fader controls the volume of all the sound switches that have been linked to it. Moreover, if a user has turned a multiple of these sound switches on, and then the user turns the one switch off that was last selected, the fader controlling these switches will automatically move to the previously selected sound switch and so on.

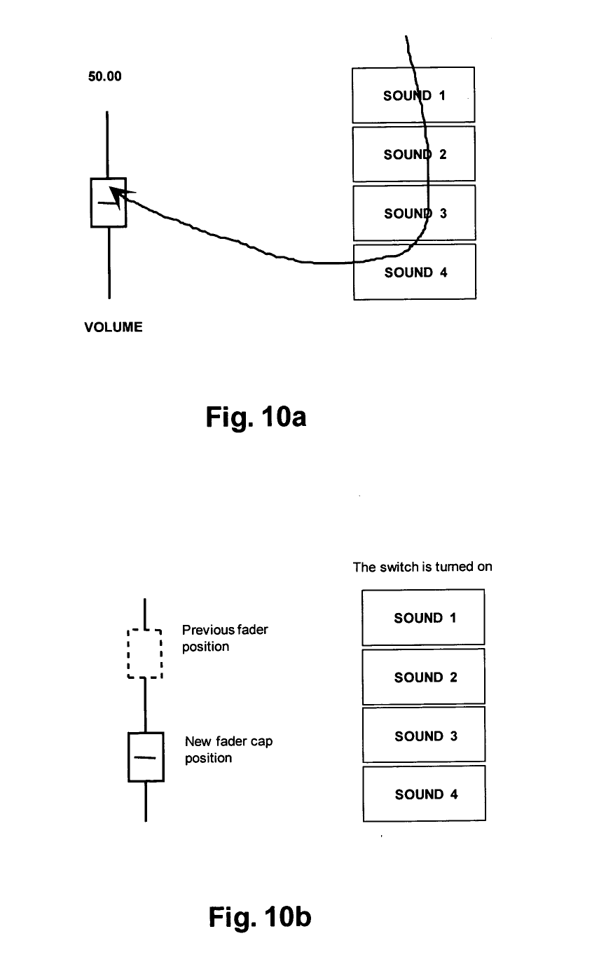

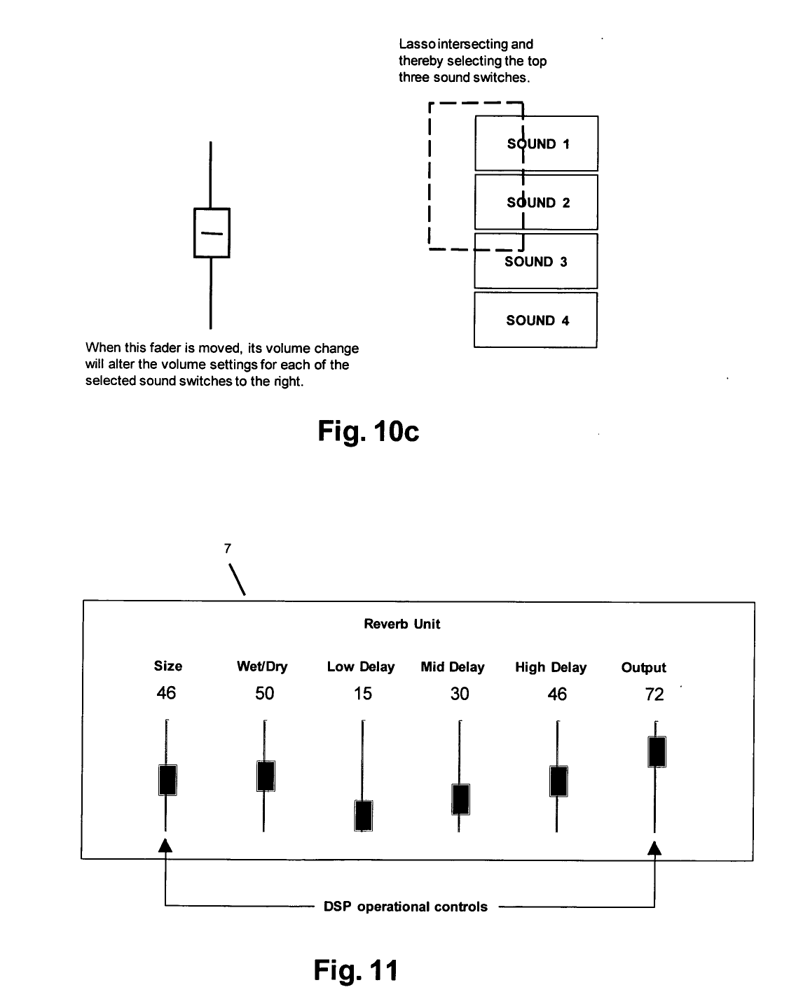

As a final note, it is possible to enable the fader to be used to modify more than one sound switch at a time. Many methods are possible. One such method is to select multiple sound switches by using a lasso or by touching various switches while holding down a key on a keyboard, e.g., an Alt key. Then these switches can be grouped (glued) together. Then when the fader that controls them is adjusted, this adjustment will apply to all of the sound switches (and subsequently to their sounds) at one time. These approaches are illustrated in FIGS. 10a-10c.

FIG. 10a illustrates the drawing of a red control arrow which intersects four sound switches and points to a single fader. After the drawing of this arrow is recognized by the software, and the arrow logic is determined to be valid its arrowhead turns white (not shown). Then its arrowhead can be touched to activate the arrow logic. This establishes the fader as a volume control for the sound switches that were intersected by the drawing of the red arrow. The volume action of the fader can be a software default, which can be user modified to be another type of action by making a selection in the Info Canvas object for that fader. Other choices could include, start time, end time, “in” crossfade, and “out” crossfade.

In this case, the sound switches that the arrow is drawn from, are controlled by the fader that the arrow was drawn to. In a typical sense, this is not the way a red control arrow logic is designed to work. However, the interpretation of the arrow logic by the sound system uses a context to define this interpretation. In this case the context is the combination sound switches, a fader and the drawing of a red control logic arrow to intersect them. Here, this context tells the sound system's interpretation of the arrow logic software how it should interpret a drawn “send to” arrow.

The context modifies the usual behavior of the red control arrow and effectively reverses its source and target objects. This permits the fader to control the sound switches volume. The designation that the fader controls volume is another part of the interpretation of the context described above. For more information about contexts, see U.S. patent application Ser. No. ______, filed Sep. 13, 2004, entitled “Method for Creating User-Defined Computer Operations Using Arrows”.

FIG. 10b illustrates the turning on of a sound switch and having the volume setting for this switch change the position of the fader cap for the volume fader that is controlling that sound switch. When a sound switch is turned on, the fader's cap moves from its previous position (the previous sound switches volume) to a new position. The new position indicates the current volume setting for the currently activated sound switch. In this case, it's the top sound switch as shown below.

FIG. 10c illustrates the lassoing of multiple sound switches such that the fader can be used to modify the volume setting for all of these switches at once. If the individual volume settings for each of these sound switches are different, which is likely to be the case, then adjusting the fader will add the same value offset to each of the selected sound switches' sounds.

More about DSP Switches

The creation of a DSP switch is more than the creation of a mere control. As part of the creation of a DSP switch, the software creates a DSP device that has individual controls, which can be manipulated by a user. This is an actual operable DSP device that can be used to modify sound or video sources.

Let's say that three DSP switches are created: EQ, delay and pan. To create these switches a user would first create three switches, for instance by using Object Points. For instance to create the first switch, two points would be touched onscreen within a prescribed time period, e.g., 1 second. Then a switch would appear. Next the text EQ, would be typed on this switch. Upon hitting the Escape key or Enter key or its equivalent, the DSP switch would be created by the software and the DSP device that is called for by that switch will be also created.

FIG. 11 is an example of a reverb DSP device. It shows the operational controls for a reverb device. Once the reverb DSP is created, by let's say typing “reverb” on a switch, the software creates these controls for this DSP device and the DSP device itself. The controls for this DSP device may be placed into a VDACC (Visual Design and Control Canvas) object 7.

Creating a Mix Fader for DSP Switches

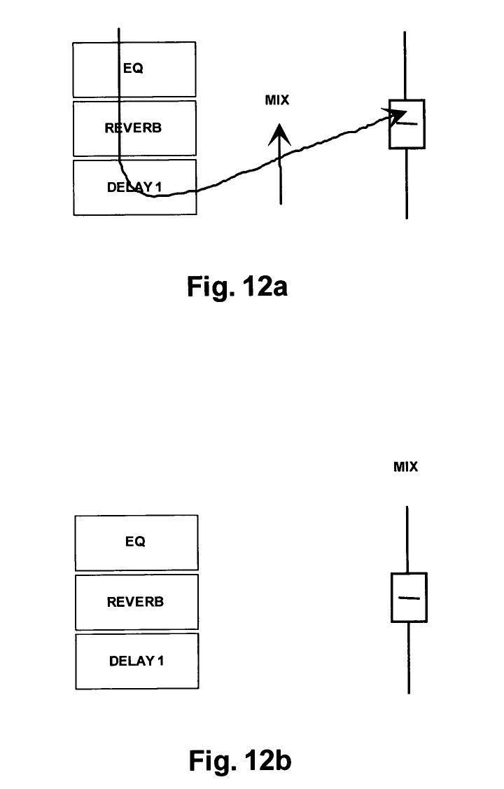

FIG. 12a shows the process of creating a “mix” fader for three DSP switches in accordance with an embodiment of the invention. To create a “mix” fader for these three DSP switches, a user would draw a fader and then draw a red “control” arrow that intersects each of the DSP three switches and then points to (intersects or nearly intersects) this fader. Then a modifier arrow will be drawn that intersects the first drawn arrow and the word “mix” is typed for that modifier arrow. Referring to FIG. 12b, upon hitting the white arrowhead of this recognized arrow, the following will occur:
a. The word “mix” appears above the fader.
b. In this software, if the DSP device has a valid “mix” control included as part of its operational controls (such as a delay or reverb devices, which have mix faders as part of their controls), then this mix fader is set to the value of the mix fader for that DSP device. Moving this external mix fader will directly change the mix fader for the DSP device. In addition, changing the mix fader that is part of the DSP operational controls will change the external mix fader.

For DSP devices that don't have a mix fader as part of their operational controls, e.g., an EQ, the external fader effect value defaults to 100%. This means that the fader is automatically moved to the top of its fader travel. As a user moves this fader downward, it changes the mix between the selected DSP signal and the original dry signal.

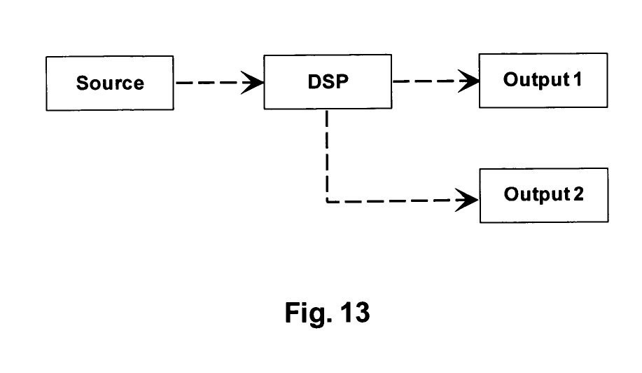

This arrangement gives a user access to the unprocessed signal and to the processed signal via this fader. This is illustrated in FIG. 13.

If the external mix control is set to 100% then only Output 1 is audible in FIG. 12. If the external mix control is set to 0% then only Output 2 is audible. If the external mix control is set to 50%, an equal volume of both outputs is audible.

If a processing delay occurs through the DSP, then the software automatically delays the processed signal or signals to equal the time or arrival of the non-processed signal(s).

The Show Switch

The drawn arrows, with their associated arrow logics, disappear once they are recognized and implemented by the software. If these arrows are used to create a link or a signal path, having them disappear means that a user can no longer see a visual indicator of the link or the signal path. The solution to this problem is the “Show Switch.” This switch enables a user to see signal paths and switch links.

Using the Show Switch to Illustrate a Signal Path.

There are two types of signal paths, serial and parallel. A serial signal path means that a sound source goes to one DSP device and then goes progressively from that DSP device to another until the signal reaches the output. With a serial signal path there is one signal that goes through multiple devices one after the other. In other words, the signal goes in one device and out of that device into another device and out of that device into another device and so on.

A parallel signal path means that a signal takes multiple paths to the output, e.g., if you connect the sound source to a DSP device and then connect the same sound to a different DSP device, there will be two parallel signal paths to the final output—one signal path from each DSP device.

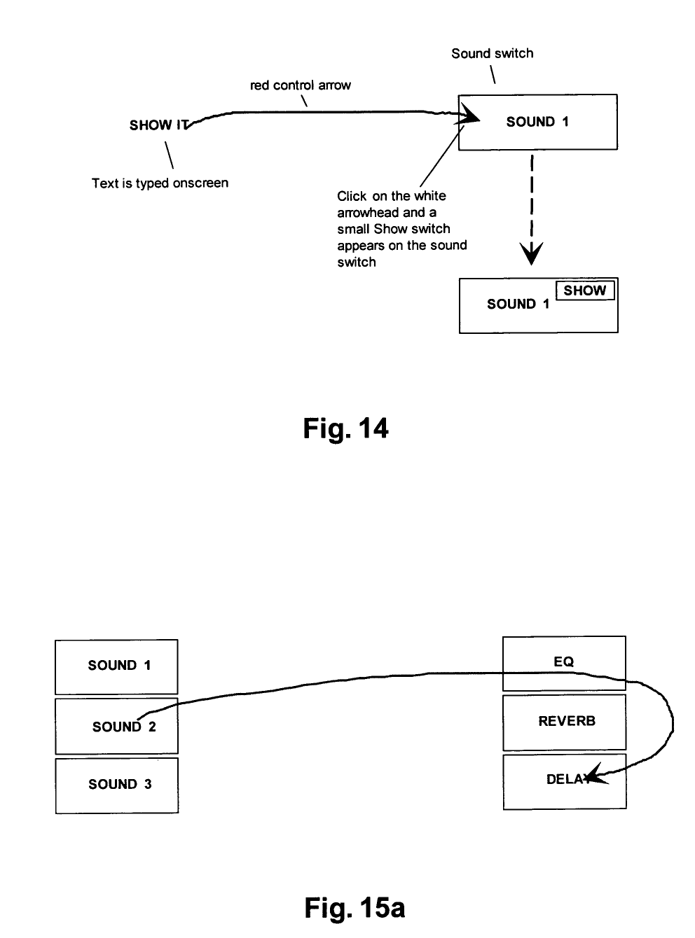

FIG. 14 shows a method of creating a “Show Switch” in accordance with an embodiment of the invention.

(1) Type the word “Show It” onscreen and hit the Esc key or its equivalent.

(2) Draw a red control arrow from the “Show It” text to a sound switch. Upon the mouse up-click, a white arrowhead will appear for the drawn and recognized red arrow.

(3) Touch this white arrowhead and the red arrow will disappear and a small auxiliary switch will appear on top of the sound switch to which the red arrow had just been drawn. This auxiliary “Show” switch will appear as a much smaller switch positioned somewhere on the sound switch. For example, it could appear in the upper right corner.

The small Show switch can be resized, have its text changed or be moved to any new position either on the sound switch or outside the perimeter of the sound switch.

(4) Activating the show switch by pressing it or by left-clicking on it or the equivalent, will cause the signal path to be shown by various methods.

One method is to outline the DSP switches that exist in this signal path with a color or a graphic (e.g., a shaded area around the switch) or with an animation (e.g., a pulsating perimeter or some other noticeable movement).

One example of this operation is that if the sound source is connected to the DSP switch(es) via a parallel signal path, then one color will be chosen to show this, e.g., causing a light blue outline to appear around the DSP switch(es).

If however, the sound source is connected to the DSP switch(es) via a serial signal path, another color would be chosen, e.g., red. In addition, if it is a serial connection, a number can appear near each DSP switch showing the order of that DSP switch in the serial connection. For example the first DSP switch in the signal path would be labeled “1” and the second DSP switch in the signal path would be labeled “2” and so on. This is described below.

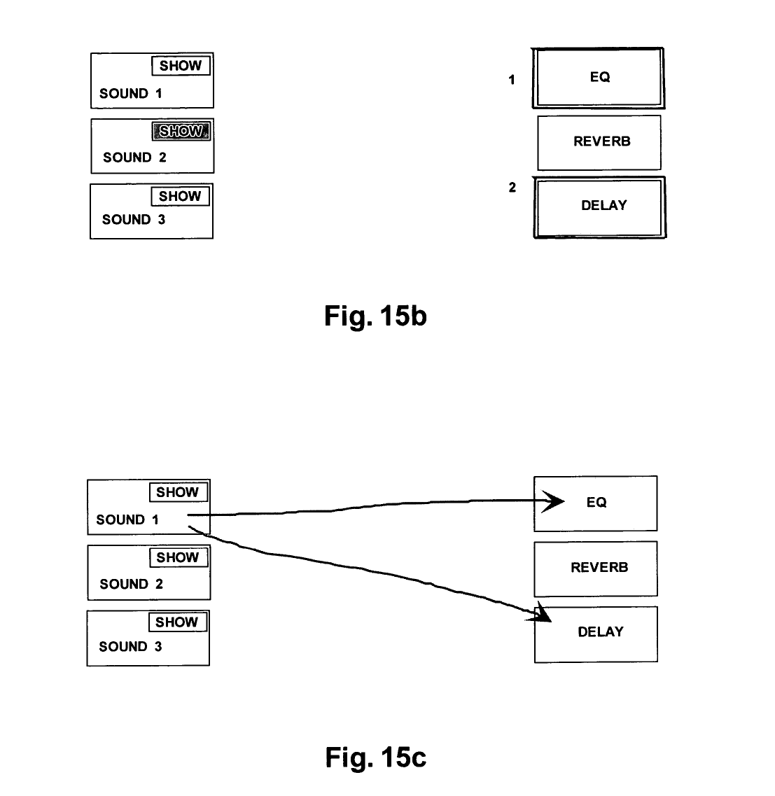

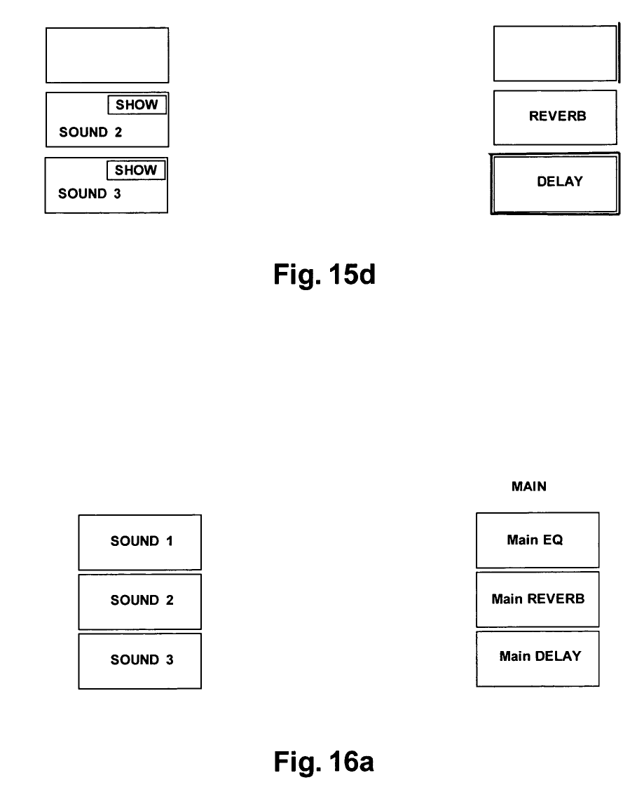

FIG. 15a shows the drawing of a gray “send” arrow from sound switch “Sound 2” to DSP switches “EQ” and “DELAY.” The drawing of this arrow creates a serial signal path. In other words, the signal SOUND 2 goes first to the input of the EQ device and then to the input of the DELAY device.

In FIG. 15b, the SHOW switch for the Sound 2 switch has been turned on. This in turn shows the signal path for this Sound 2 switch. The signal path is EQ and Delay.

Since the signal path that was created by the drawing of the arrow in FIG. 15a is serial, the color red appears for the DSP devices that were intersected by the drawn and recognized “send to” arrow. In addition, a sequential number can appear next to each of the DSP switches that is part of the signal path. In the case of FIG. 15b, EQ is the first in the serial chain and Delay is the second in this same serial chain. Thus, there is a number 1 and 2 next to each DSP switch respectively. These numbers are valuable, because they clearly indicate the order of the signal path through various DSP devices. Without the numbers a user would know which DSP devices are in the serial path, because they each have a red outline around them, but there would be no easy way to know the order that these DSP devices appear in the serial signal path.

Referring to FIG. 15c, two gray “send” arrows have been drawn from SOUND 1 switch to the EQ and DELAY DSP switches respectively. This is an example of a parallel signal path. The audio signal from SOUND 1 is sent to both the EQ and DELAY DSP devices. The signal does not travel through one DSP device to the other. Instead it is sent to both of them directly, and thus it is a parallel signal path.

In FIG. 15d the show switch for SOUND 1 has been activated. As a result, the two DSP switches that it is being sent to via a parallel signal path are highlighted with a blue outline. This blue outline indicates that these DSP switches are connected to the SOUND 1 switch via a parallel signal path.

The Toggle Switch

The toggle feature has two functions in the software of this invention:
(1) It enables a user to activate one sound switch at a time. With the toggle feature activated, turning on one sound switch will automatically turn off all other sound switches that are controlled by the same toggle control.
(2) The toggle control enables a user to signal the software to build a separate set of DSP devices that match the current set of Main DSP devices.

To enter the toggle mode, a user would do the following: (1) create a switch and type the word “Toggle” on it and hit Esc or its equivalent (this creates a toggle switch), and (2) turn on this toggle switch. Turning on this switch activates the toggle mode.

In general, regarding (1) above, if a user has created a number of sound switches, turning on a toggle switch and then turning on one sound switch after the other, will successively cause the previously activated sound switch to automatically be turned off. In this manner, only one sound switch at a time will be on.

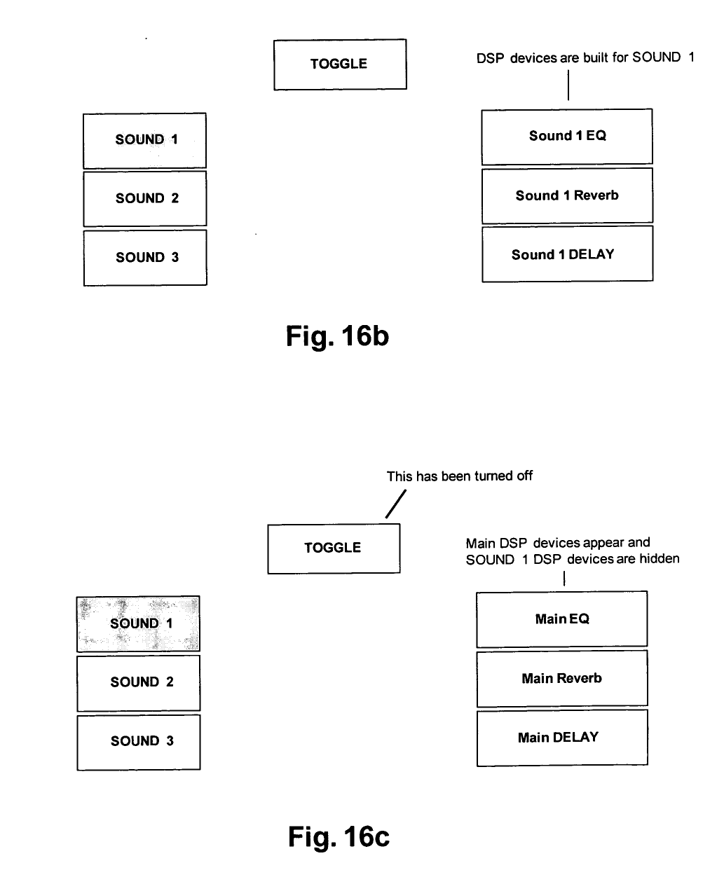

Regarding (2) above, this requires more explanation. Consider FIG. 16a. On the left is a row of sound switches and on the right is a row of DSP switches. These DSP switches are called “Main” DSP. They have the distinction of being capable of receiving multiple inputs from multiple sound sources.

In FIG. 16b a toggle switch has been created and has been activated. Then Sound 1 switch is turned on. When this Sound 1 switch is turned on, the software automatically creates another set of DSP devices that match the Main devices shown in FIG. 16a. These new devices are given the name as the sound switch that was activated when the toggle switch was on. As each additional sound switch is turned on, the software builds a separate set of the DSP devices for it. In this example, when this process is done, there will be four separate sets of DSP devices: one Main set and a separate set for each of the three sound switches.

As shown in FIG. 16c, when the toggle switch is turned off, the DSP switches revert to being controls for the Main DSP devices. In this case, any sound switch can be turned on and it can have the sound source or video source that it represents sent to any of the Main DSP devices.

When the toggle switch is turned off, these DSP devices again become the controls for the Main DSP devices. The individual controls for each of these Main DSP devices can now be accessed and modified according to user needs.

There are two methods to access the operational controls for any DSP switch: (a) right-click on the DSP switch and in its Info Canvas object turn off the entry “Controls Hidden,” and (b) create a Show Switch for the DSP switch and activate the Show Switch to cause the operational controls for that DSP device to appear onscreen. Creating and operating a Show Switch for a DSP switch is the same as creating a Show Switch for a sound switch.

More examples of using the Toggle switch are as follows:

a. Toggle Mode with Sound Switches and No DSP:

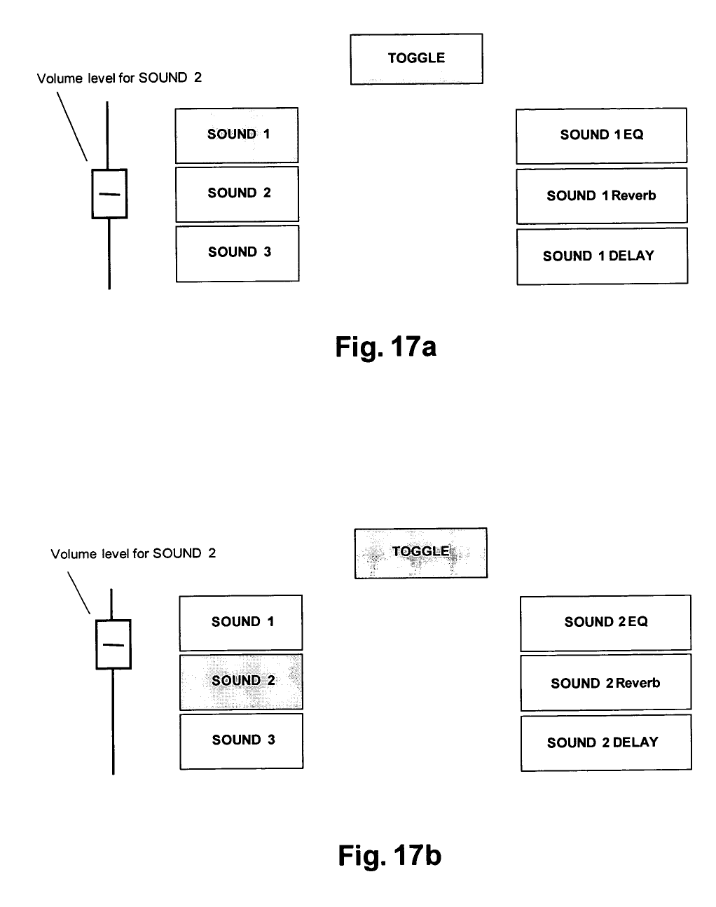

In FIG. 17a, three sound switches have been created. Then a toggle switch has been created and turned on. The Sound 1 switch has been activated. This automatically turns off all the other sound switches. This is different from a typical audition mode. A typical audition mode works such when you touch a sound switch, it plays that sound file from the beginning. When you touch another sound switch, it stops the playback of the first sound switch and starts the playback of the next sound switch that is touched from the beginning.

The toggle mode of this invention does the following:
(1) A user clicks on a sound switch and hits (activates) the play function. This can be done by turning on a Play switch.
(2) The user clicks on another sound switch and the playback will continue from the point in time where the second click occurred on the second sound switch.

Referring to FIG. 17a, there are three sound switches controlled by a single fader device. Activating the toggle switch enables one to view the independent volume of each sound switch. As each sound switch is turned on, the fader's position changes to show the fader's value for that sound switch. In FIG. 17b, Sound 2 switch has been activated. This automatically turns off Sound 1 switch and the fader's value changes to show the value set for Sound 2 switch.

b. Using DSP in the Toggle Mode.

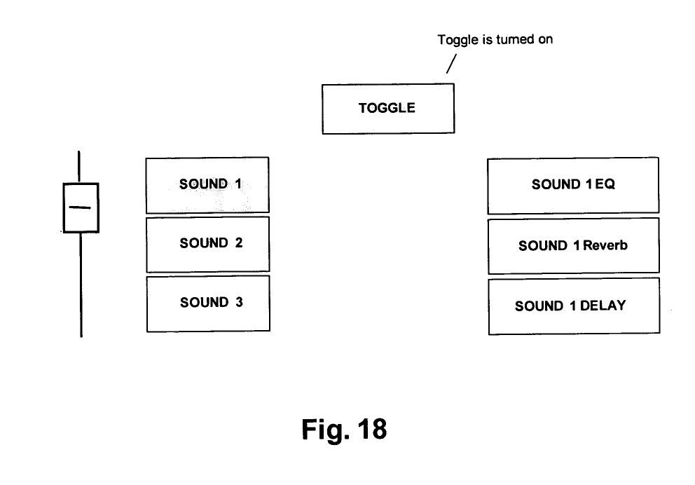

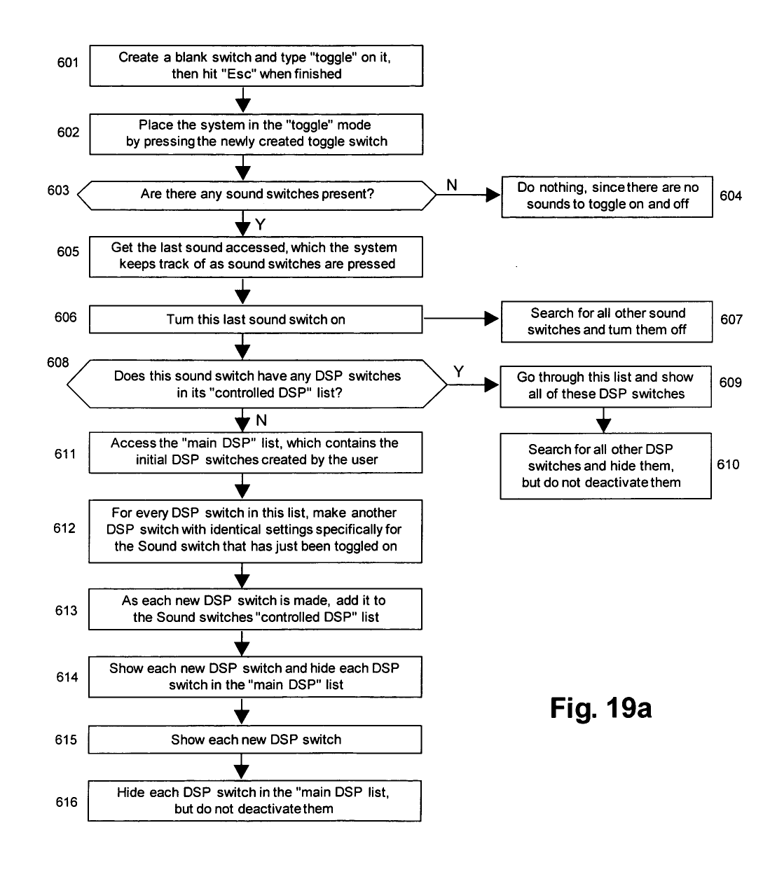

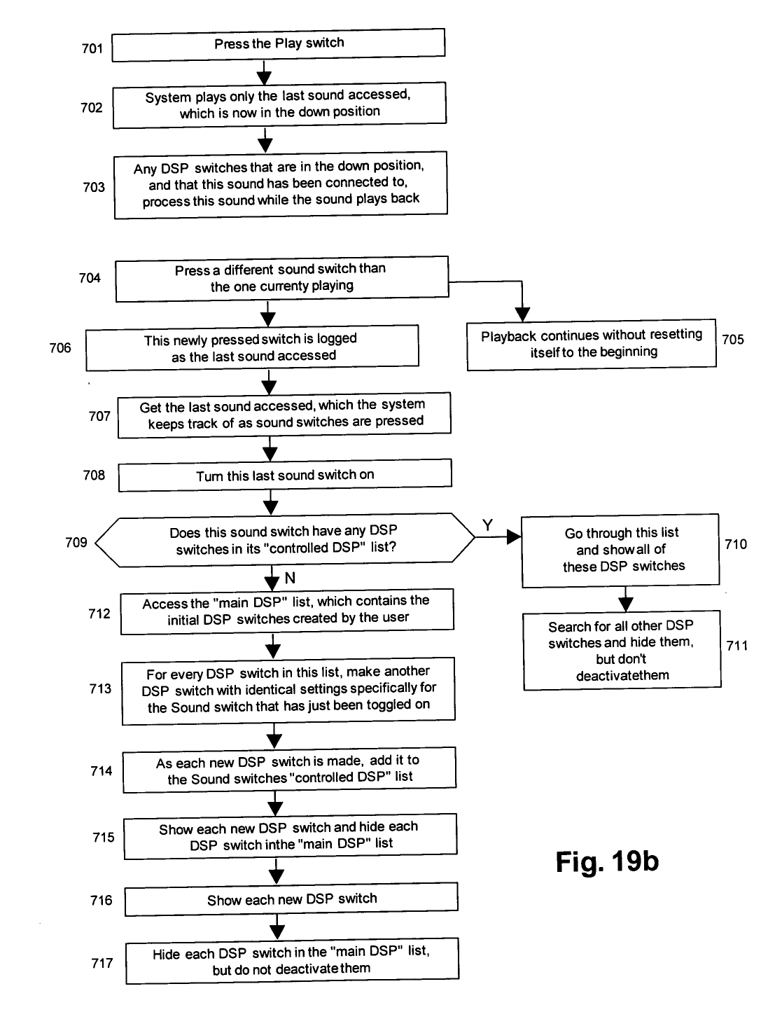

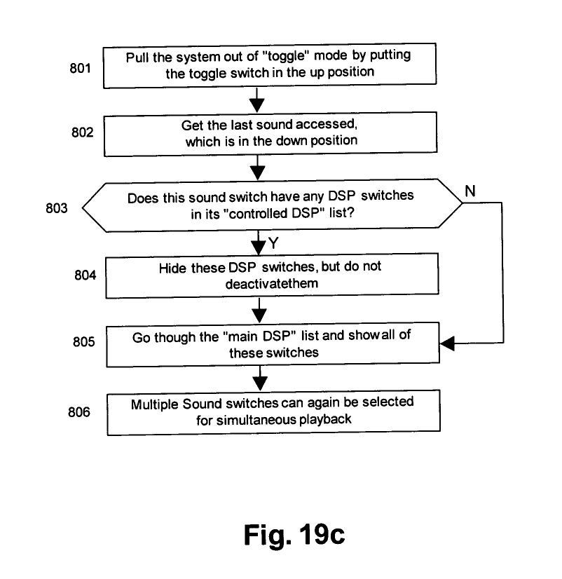

FIG. 18 illustrates the use of the Toggle Switch with DSP switches. This figure presents three sound switches and three DSP switches that have been created by the above described methods. One approach to the use of the toggle mode with DSP and sound switches would be the following:
(1) Turn on the toggle switch.
(2) Touch any sound switch, e.g., SOUND 1, when the toggle switch is on, and a duplicate DSP device will be created for each of the Main DSP devices for the SOUND 1 switch. The original Main DSP device(s) still exist, but they're hidden from view. See flowcharts of FIGS. 19a, 19b and 19c.

Each new DSP switch is labeled to match the name of the sound switch that was clicked on (turned on) while the toggle switch was on. For example if the toggle switch is on and a user turns on the SOUND 1 switch, three DSP devices will be automatically created by the software. They are “EQ”, “Reverb” and “DELAY” devices.

As an alternate to this operation, a user could turn on the toggle switch and then turn on one or more DSP switches and then turn on a sound source switch, e.g., “SOUND 1.” Then in this case, only the DSP switches that are turned on will be duplicated and named with the “SOUND 1” name. Let's say that only the EQ switch is on when the toggle switch is on, then when the SOUND 1 switch is turned on, only a duplicated for the EQ device will be created for the SOUND 1 switch. If the Reverb and Delay switches are on when the toggle switch is on, and if a user then turns on the SOUND 3 switch, a Reverb and Delay device will be created for that sound switch, but not an EQ device, and so on.

FIG. 19a is flowchart that describes the general operation of creating a toggle switch and operating it in accordance with an embodiment of the invention. In this figure is described an audio solo logic that solos in place with all of the DSP active.

In block 601, a switch is created and the key word “toggle” is input on it. Then the Esc key or its equivalent is activated to finish the creation of the toggle switch.

In block 602, the newly created toggle switch is activated by left-clicking on it or the equivalent.

In block 603, the software checks to see if there are any sound switches present onscreen.

If no, then in block 604, nothing occurs, since there are no sounds to toggle on or off.

Referring again to block 603, if yes then in block 605, the software recalls the last sound which had been accessed. It is possible that a user may turn on a sound switch and then turn it off so that there are no sound switches on at the time that the toggle switch is activated.

In block 606, this last sound switch is turned on.

In block 607, the software searches for all other sound switches and turns them off if any are found.

Also, in block 608, the software checks to see if the sound switch of block 606 has any DSP switches in its “controlled DSP” list. These are the DSP devices that have been created for this sound switch, by the process of turning on one or more DSP switches, turning on the toggle switch and then turning on a sound switch or by the drawing of a gray “send to” arrow from one or more sound switches to one or more DSP switches.

If yes, then the software goes through this list and shows all of the DSP switches onscreen.

Then in block 610, the software searches for all other DSP switches and hides them, but it does not deactivate them. For instance, if various Main DSP switches are visible onscreen, the software hides them, but lets them remain active. To deactivate these DSP devices would possibly cause an undesirable change in the audio signal. In this case, the toggle enables a user to see the DSP devices (if any) for the last accessed sound switch, without deactivating the Main DSP devices in the process.

If no, then in block 611, the software accesses the main DSP list which contains the initial DSP switches created by the user. When DSP switches are first created by a user, one possible default is that they are designated to be Main DSP switches that control DSP devices in the Main signal path—e.g., the Main console channel. These DSP switches are entered into the “Main DSP” list.

It is the use of the toggle switch that then permits a user to create duplicate versions of these DSP devices for any individual sound switch. A sound switch represents a sound. This sound could also represent a single audio channel. Often this is the case. Therefore, when the toggle is used to create duplicates of one or more Main DSP devices for a given sound switch, these duplicate DSP devices are available (not necessarily on or active) for that sound's audio channel.

Then in block 612, for every DSP switch in this list, a duplicate DSP switch (and its associated DSP device with all of the operational controls settings for that device) for the sound switch that has just been turned on by the toggle software is made.

In block 613, as each new DSP switch is made, it is added to the sound switches “controlled DSP” list.

In block 614, each new DSP switch in the sound switches “controlled DSP” list is shown onscreen and all of the DSP switches in the “Main DSP” list are hidden but not deactivated.

At block 615, the software makes a final check that each new DSP switch is shown onscreen.

At block 616, the software makes a final check that each DSP switch in the “Main DSP” list is hidden but not deactivated.

FIG. 19b is flowchart that describes the process of playing sounds in the toggle mode in accordance with an embodiment of the invention. This flowchart starts at the end of FIG. 19a. The toggle switch is on and one sound switch has been turned on and the DSP switches in its “controlled DSP” list are visible onscreen.

In block 701, the Play switch is activated. This starts the playback of audio and/or animation and/or video.

In block 702, the software plays the last sound accessed.

At block 703, any DSP switches that are in the down position and that are connected to the sound switch that is on, will process the sound while that sound switch plays back.

At block 704, a sound switch is activated that is different from the sound switch whose sound is currently playing back.

Block 705 explains that if this sound playback is stopped and then started again, that it continues from where it was last stopped and does not start back at the beginning of the sound.

At block 706, the new newly pressed sound switch is logged by the software as the last sound accessed.

At block 707, the software recalls the last sound accessed. The last sound that was accessed is kept track of by the software. The software could keep track of all sound switches that have been accessed, but it needs to keep track of the last one.

At block 708, this last sound switch is turned on by the software.

At block 709, the software checks to see if this sound switch has any DSP switches in its “controlled DSP” list. If yes, at block 710, it goes through this list and shows all of these DSP switches onscreen. Then at block 711, it searches for all other DSP switches that may be visible onscreen and hides them, but does not deactivate them.

Continuing from block 709, if NO, then at block 712, the software accesses the “Main DSP” list which contains the DSP switches initially created by the user.

At block 713, for every DSP switch that is found in this list the software creates a duplicate DSP switch, which has identical settings, for the sound switch that has just been toggled on.

At block 714, as each new DSP switch is made for the sound switch, it is added to that sound switches “controlled DSP” list.

At block 715, the software shows each newly created DSP switch for the sound switch onscreen and hide each switch in the “Main DSP” list.

At block 716, the software makes a final check that each new DSP switch is shown onscreen.

At block 717, the software makes a final check that each DSP switch in the “Main DSP” list is hidden but not deactivated.

FIG. 19c is a flowchart that shows the process of exiting the toggle mode in accordance with an embodiment of the invention.

At block 801, the toggle switch is turned off and this pulls the system out of the toggle mode.

At block 802, the software recalls the last sound accessed which is in the down position.

At block 803, the software checks to see if this sound switch has any DSP switches in its “controlled DSP” list.

If no, then at block 805, the software goes through the “Main DSP” list and shows these switches onscreen.

If yes, then at block 804, the software hides the DSP switches for the sound switch of block 803, but does not deactivate them. These DSP switches are in the sound switches “controlled DSP” list.

At block 806, it is now possible for a user to select multiple sound switches at one time for simultaneous playback.

Save Me Switch

The Save ME switch is in part designed to enable users to easily create a composite sound from one or more sound sources and one or more DSP devices. There are at least two forms that this composite sound can take: (1) an audio file, i.e., a .wav, .ogg or .AIFF sound file, etc., and (2) a .sme file. This .sme file type is explained later.

Creating a Save Me Switch.

To create a Save Me switch, a user would create a blank switch and then type “Save me” on the switch and then hit the Esc key or its equivalent.

Software Implementation of the Save Me Switch.

The Save Me switch takes the currently selected sound (i.e., the currently activated sound switch) and any DSP that is connected to the sound and is currently selected (namely, the DSP switch(es) that are turned on) and creates a new switch that controls the signal path of the selected sound and the selected DSP that is being used to process this sound.

The Save Me switch is a dynamic control in software. Turning on the Save Me switch causes the software to build a new switch, which retains the complete signal path of the currently selected sound source(s) and the currently selected DSP device(s) as a setup.

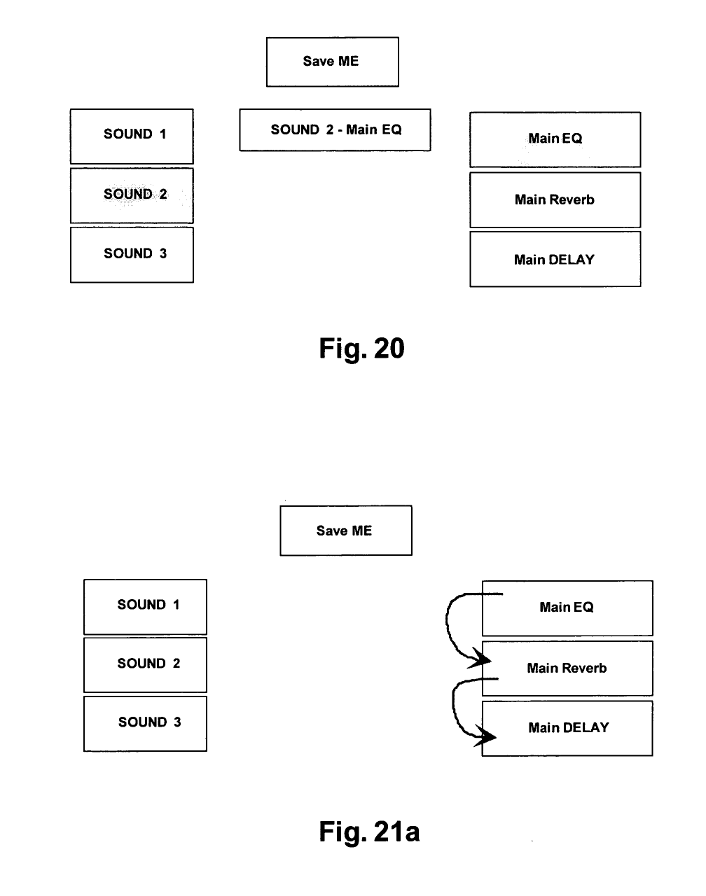

In FIG. 20, there are three sound sources and three DSP devices. Let's say that the condition of these switches is as follows: all three sound switches (sources) are connected to all three DSP switches. Let's say the signal path is serial, although any signal path or combination of signal paths can be used by the Save Me switch to create a “combination” switch.

In FIG. 20, SOUND 2 and Main EQ are turned on. In addition, the Save Me switch is activated. This causes a new switch to be created that will be given the title: “Sound 2 Main EQ” by the software. This new switch is referred to as a “combination” switch.

The activation of the Save Me switch causes the current signal path to be saved as a new sound on a new switch. But this isn't really a new sound. It's a dynamic setup of a signal path. This signal path can then be recalled by pressing (activating) the newly created switch, entitled: “Sound 2 Main EQ.”

If the user has not connected a DSP switch to the sound switch, even if the DSP switch is turned on, it will not be put into the combination switch created by activating the Save Me switch. In other words, the use of the Save Me switch only pertains to DSP devices that is connected to the signal path. These devices are connected by graphical means.

Connecting Switches Together in a Signal Path and Activating the Save Me Switch

A. Create One or More Sound Switches.

Create a blank switch and type the name of a valid sound file on it and hit the Esc key or its equivalent or drag the name of a valid sound file to overlap the blank switch and then do a mouse up-click. This creates a sound switch.

This process is repeated for as many sound switches as a user wishes to create.

B. Create One or More DSP Switches.

Create a blank switch and type a known word for a DSP device, e.g., echo, delay, EQ, comp (for compressor) or pan, etc. Type a separate known DSP word for each switch that one wishes to create a DSP device for. After each typing of each switch, hit the Esc key or equivalent and a DSP device will be created for that switch.

Note: each time a DSP switch is created and upon the entering of this data to the computer (hitting the Esc key or its equivalent) the software will create a DSP device and build the operational controls for that device. As part of this process, a VDACC object will appear with all of the operational controls for the DSP device that has been just created. These controls are then immediately hidden, until the user turns off the entry “Controls Hidden” in the Info Canvas object for this DSP switch. Upon the deactivation of this Info Canvas entry the operational controls for that DSP device will appear.

These controls may be placed into a VDACC object. These controls may consist of faders and labels for those faders and possibly switches that change conditions for controls.

C. Connect the DSP Switches into a Signal Path.

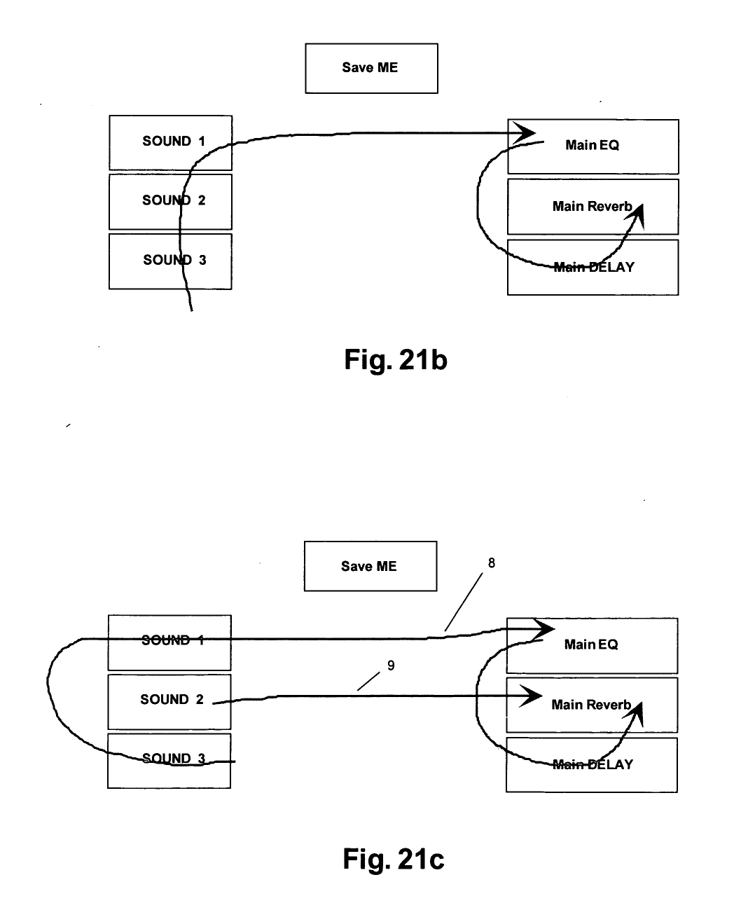

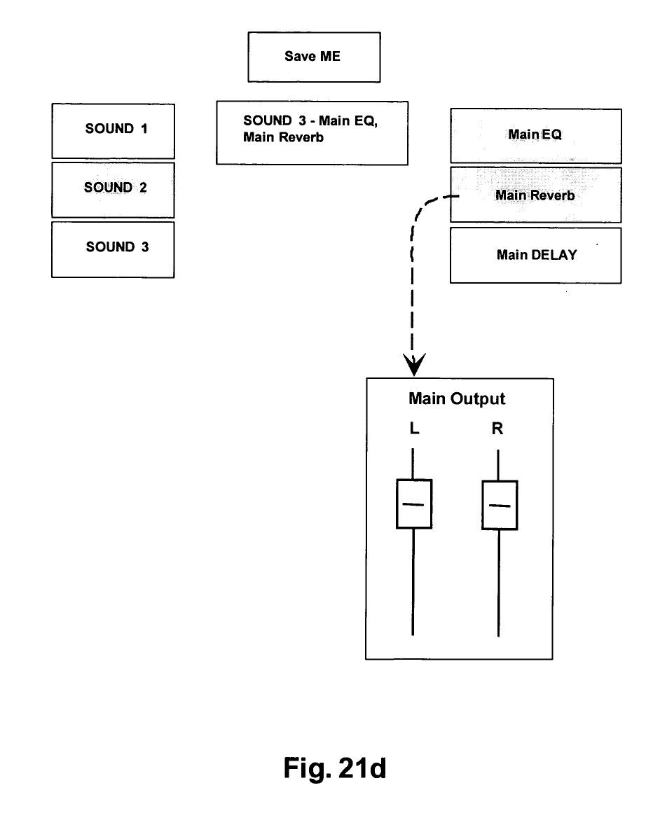

Referring to FIG. 21a, DSP switches are connected into a single signal path by drawing a gray arrow from each DSP switch to the switch below it. This gray arrow represents the arrow logic “send to.” This arrow logic can be represented as a sentence which reads: “Send the item(s) that are encircled, intersected or nearly intersected (“intersected”) by an arrow to the item(s) that the arrow points to.”

Creating a Signal Path.

Referring to FIG. 21b, a signal path is created by drawing a gray arrow from the EQ switch to the DELAY switch and back to the Reverb switch. The purpose of this is to create a single signal path between these three DSP devices. The order that the DSP switches are intersected determines the signal flow in the audio path. In this case the audio signal flows from the EQ to the DELAY to the Reverb. If the arrow had been drawn to intersect the DSP switches in another order, this would have changed the signal flow accordingly.

When the arrow is drawn and its context is recognized as being valid for the type of arrow logic designated for that arrow, the arrowhead for that arrow will turn white. The user would then touch the arrowhead, e.g., left click on it, and the arrowhead and the arrow will disappear and the signal path connection between the three DSP devices will be made.

D. Connect the Sound Switches into a Signal Path.

Referring again to FIG. 21b, the sound switches are connected to the DSP signal path by drawing a gray arrow from the sound switches to the first DSP switch in the DSP signal path. In this case, it's the DSP switch “EQ.”

Note: the sound switches can be connected to the DSP devices with a single arrow, as shown in FIG. 21b, or a separate arrow can be drawn from each sound switch to the desired EQ switch.

Referring to FIG. 21c, let's say that a user wanted SOUND 1 and 3 to be input to the Main EQ, which would pass these source inputs in turn to the DELAY and then to the Reverb. This is shown as arrow 8. Now let's say it is desired to have SOUND 2 not be processed by the EQ or DELAY, but only by the Reverb. This is accomplished by drawing arrow 9 directly from SOUND 2 to the Reverb switch.

FIG. 21c shows a Save Me switch which has been created above the sound and DSP switches. The Save Me switch can now be used to create combination switches consisting of any combination of sound and DSP switches and their respective signal path.

E. Turn on the Save Me Switch

Referring to FIG. 21d, to operate the Save Me switch, a user would turn on the sound source switch or switches of their choice and then turn on the DSP switch or switches of their choice. In this case, the SOUND 2, Main EQ and Main Reverb switches are selected. By turning on these switches the user establishes a sound source, DSP processing and one or more signal paths. The result of these is a processed sound. This processed sound can then be saved by activating the Save Me switch. This results in the creation of a new “combination” switch. The new combination switch is given a name, usually this name is the combined names of the sound source(s) and the DSP device(s) that are applied to it and in the order that the DSP appears in the signal path.

Note: Turning on a switch can be accomplished by left-clicking on the switch, making a verbal command, e.g., “switch on”, or by some other suitable method.

When the Save Me switch is pressed, the software creates a new combination switch entitled: “SOUND 3—Main EQ, Main Reverb.” When this “SOUND 3—Main EQ, Main Reverb.” switch is pressed, it recalls the setup which it has saved to it. In this case, this setup is the SOUND 3 source being sent to the Main EQ and Reverb device along the signal path established by the drawing on the gray arrows, as shown in FIG. 21c.

This setup also includes the sending of the signal from the Main Reverb device to an output.

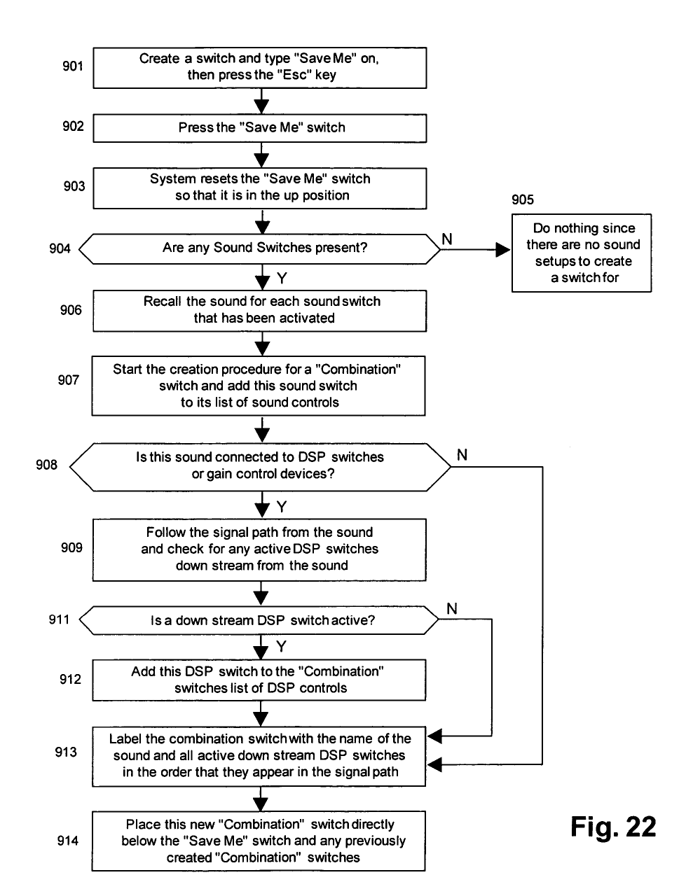

FIG. 22 is a flowchart that elucidates the creation and operation of the Save Me switch in accordance with an embodiment of the invention.

At block 901, switch is created and the key phrase “Save Me” is input onto it. Then this information is input into the software by pressing the Esc key, Enter Key or its equivalent.

At block 902, the Save Me switch is activated.

At block 903, the system resets the Save Me switch so that it is in the up position. The Save Me switch is a momentary switch action. When pressed, it activates, but upon the mouse up-click, or its equivalent, the switch is immediately reset and is ready to be activated again.

At block 904, the software checks to see if any sound switches are present.

If no, then at block 905, the software takes no action because there is no sound setups to create a switch for.

If yes, then at block 906, the software recalls the sound for each sound switch that has been activated. More than one sound switch can be activated at once.

At block 907, the creation procedure for a “Combination” switch is started. The sound switch of block 906 is added to its list of sound controls for this Combination switch.

At block 908, the software checks to see if this sound is connected to DSP switches or gain control devices.

If yes, then at block 909, the software checks along the signal path for any active DSP switches that are downstream from the sound. Downstream means any processing that takes place after this sound's position in the signal path.

At block 911, the software checks to see if a down stream DSP switch is active.

If yes, then at block 912, the software adds this DSP switch to the “Combination” switches list of DSP controls.

Then, referring to block 911, if no, and to block 912, then the software labels the “Combination” switch with the name of the sound and all active down stream DSP switches in the order that they appear in the signal path at block 913.

At block 914, the software places this new “Combination” switch directly below the “Save Me” switch and any previously created “Combination” switches.

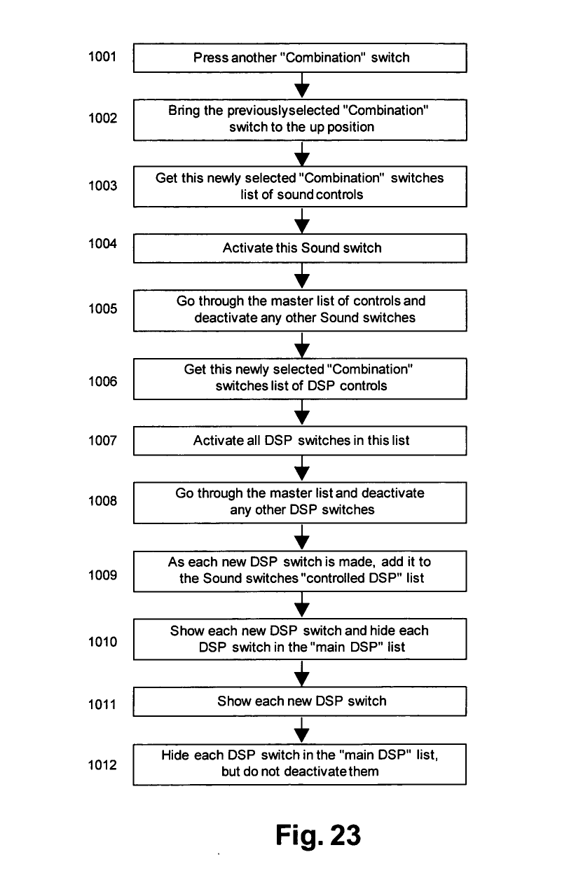

FIG. 23 is a flowchart that describes the use of the Combination switch in accordance with an embodiment of the invention. The Combination switch is created by successfully operating the Save Me switch. The Save Me switch is a method for creating switches that allow the saving of a sound signal path.

It is anticipated that users will create a multitude of combination switches through the operation of the Save Me switch. This flowchart describes the user of these combination switches.

At block 1001, the user presses (turns on) another Combination switch, following a previously activated combination switch.

At block 1002, the software then causes the previously selected Combination switch to be in its “up” position.

At block 1003, the software gets this newly selected Combination switches list of sound controls.

At block 1004, this sound(s) are activated.

At block 1005, the software goes through the master list of controls and deactivates any other sound switches. The master list is a list of all the objects that are in the current setup.

At block 1006, the software gets this newly selected Combination switches list of DSP controls.

At block 1007, all DSP switches in this list are activated.

At block 1008, the software goes through the master list and deactivates any other DSP switches.

At block 1009, as each new DSP switch is made, it is added to the sound switches “controlled DSP” list.

At block 1010, each new DSP switch is shown onscreen and each DSP switch in the “Main DSP” list is hidden.

At block 1011, each new DSP switch is shown.

At block 1012, each DSP switch in the “Main DSP” list is hidden by not deactivated.

Automatic DSP Switch Outputs.

When a user draws a gray arrow (with a “send to” arrow logic assigned to it) from any valid signal source (e.g., a sound file or a DSP device output, etc.), to a DSP switch, then a Main Output DSP VDACC object is created by the software.

This Main Output DSP VDACC object contains one or more faders. The Main Output DSP VDACC object would generally contain one output fader for each DSP device that is the final DSP in any signal path before the master (main) output. If the sound path is serial, then the DSP device, that is last in the signal path before the final output, will have a fader represented in the VDACC object. This fader controls the final output of the DSP signal path chain.

If the signal path is parallel, then each DSP device that is directly connected to the final output will have a fader that represents it located in the Main Output DSP VDACC object. In this case, for each DSP device that connects to the final output, there will be a fader added to the Main Output DSP VDACC object for that device. In this manner, many faders can exist in this Main Output DSP VDACC object.

If the last DSP device in the signal path is replaced by another DSP device, for example by the drawing of a gray arrow, which has a “send to” arrow logic assigned to it, then the fader that represented the DSP device that was just replaced will itself be replaced by the fader for the new DSP device, which is now the last in the chain before the main output.

In summary, the Main Output DSP VDACC object will hold a fader for every DSP device that is directly connected to the main master output. Furthermore, if any of these DSP devices are disconnected from the main output and reconnected to another DSP device, their fader is then removed from the Main Output DSP VDACC object, because they are no longer directly connected to the Main Output, i.e., they are no longer the last DSP device in the signal path.

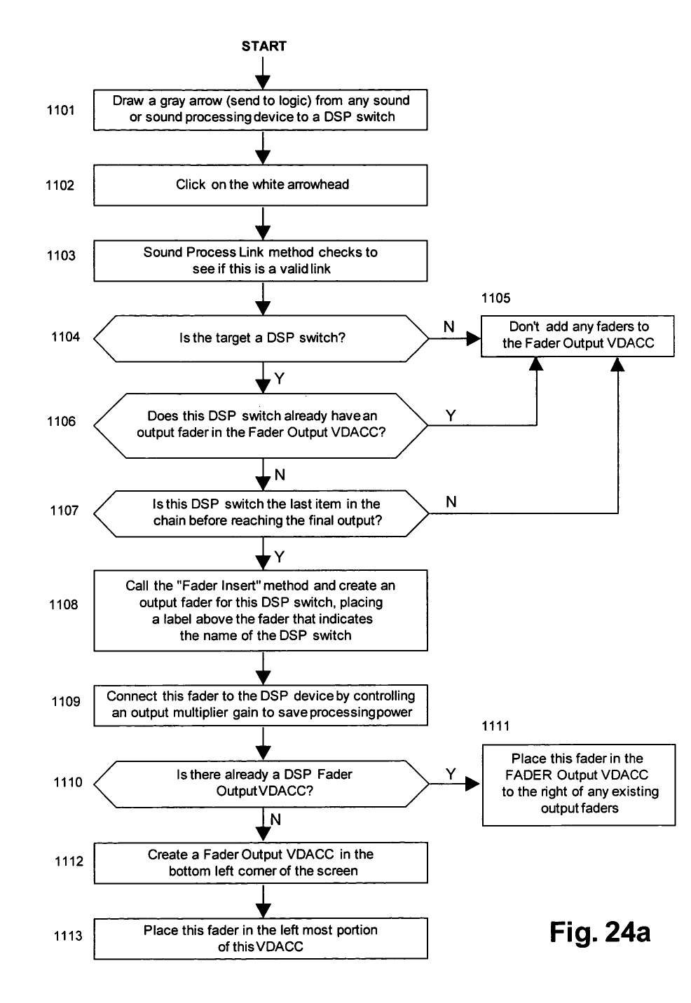

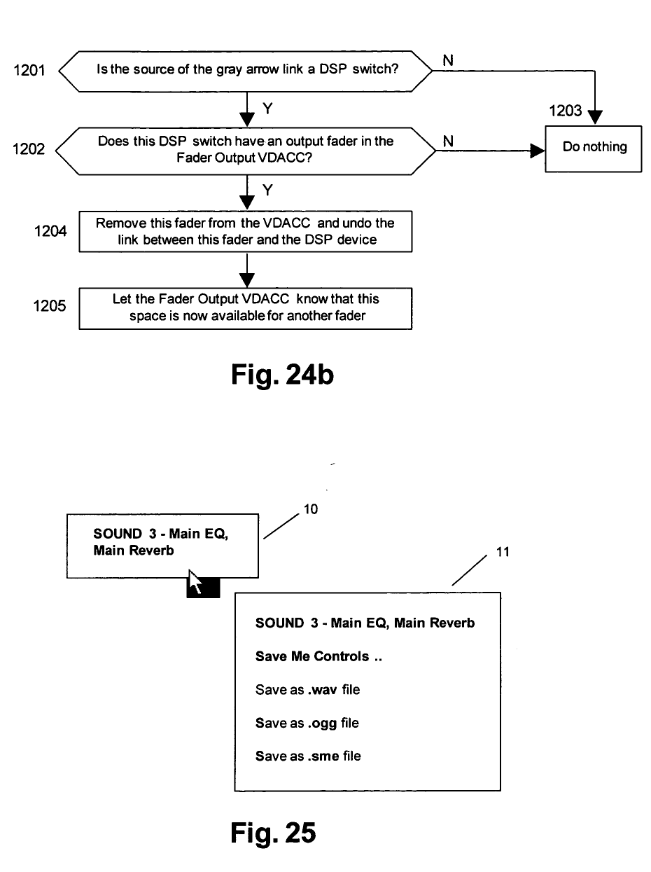

FIG. 24a is a flowchart that shows the creation of a DSP fader output VDACC object—a set of output faders for any DSP switches that are the last process in a signal path before the final output—in accordance with an embodiment of the invention.

At block 1101, a gray arrow with a “send to” arrow logic associated with it, is drawn from any sound or sound processing device to a DSP switch.

At block 1102, the white arrowhead of the drawn arrow is activated.

At block 1103, the Sound Process Link method checks to see if this is a valid link. This method in part validates the linking of objects in the system.

At block 1104, the software checks to see if the target is a DSP switch.

If no, then at block 1105, no action is taken, namely, no faders are added to the Fader Output VDACC object.

If yes, then at block 1106, the software checks to see if this DSP switch already has an output fader for it in the Fader Output VDACC object.

If yes, then at block 1105, no faders are added to the Fader Output VDACC object.

If no, then at block 1107, the software checks to see if this DSP switch is the last item in the audio chain before reaching the final output.

If, no then at block 1105, no faders are added to the Fader Output VDACC object.

If yes, then at block 1108, the software calls the “Fader Insert” method and creates an output fader for this DSP switch. The software also places a label above the fader that indicates the name of the DSP switch. The location of this label is arbitrary.

At block 1109, the software connects this fader to the DSP device by controlling an output multiplier gain to save processing power.

At block 1110, the software checks to see if a DSP Fader Output VDACC object already exists.

If yes, then at block 1111, this fader is placed in this Fader Output VDACC object to the right of any existing output faders.

If no, then at block 1112, the software creates a Fader Output VDACC object in the bottom left corner of the screen. The location of this VDACC object is purely arbitrary and it can be located anywhere onscreen.

Then at block 1113, the software places this fader in the left most portion of this VDACC object. The location of this fader in this VDACC object is arbitrary.

FIG. 24b is a flowchart that describes how the output faders are removed in accordance with an embodiment of the invention. Note: the DSP Fader Output VDACC object is a set of output faders for any one or more DSP switches that are generally the last process in a signal path before the final output.

At block 1201, the software checks to see if the source of the gray arrow link is a DSP switch. The source is the source object in the arrow logic that was passed to the sound system by the GUI.

If no, no action is taken.

If yes, then at block 1202, the software checks to see if this DSP switch has an output fader in the Fader Output VDACC object.

At block 1204, the software removes this fader from the Fader Output VDACC object and removes the link between this fader and the DSP device.

At block 1205, the software lets the Fader Output VDACC object know that this space is now available for another fader.

More about Combination Switches.

When a user turns on this switch (or any combination switch) two things happen in the software of this invention:

(1) The indicated items in the Combination switch's label are found by the software in the sound portion of the software, e.g., in a controller list or its equivalent. The items indicated on this switch (for example, switches and DSP switches) are turned on, and all other sounds and DSP switches onscreen are turned off.

(2) In addition, the signal path that was used to create this Combination switch in the first place is activated by the software.

Using the Info Canvas Object for a Combination Switch.

FIG. 25 shows the result of right-clicking on a Combination switch 10 to call forth its Info Canvas object 11. In the Info Canvas object of the Combination switch is a dynamic entry called: “Save Me Controls.” Under this category are various choices of file types. The user can select one of these file types and save the Combination switch as a sound file or let it remain a .sme file which is the software default.

Types of Combination Files

.wav Selecting this entry will cause the Combination switches' sound source and signal path (including the applied DSP to the sound source) to be processed and saved as a .wav sound file.

.ogg Selecting this entry will cause the Combination switches' sound source and signal path (including the applied DSP to the sound source) to be processed and saved as a .ogg sound file.

.sme Selecting this entry will cause the Combination switches' sound source and signal path (including the DSP applied to the sound source) to be saved as an assignment. In other words, the .sme file captures the sound source and individual DSP processes that need to be recreated in order to play back the particular sound setup represented by the Combination switch with its label.

This .sme file contains the DSP settings as well as all links needed to recreate this sound setup. For instance, these links include the “gray arrow logic” links that were used to connect the sound source to one or more DSP devices and to connect one or more DSP devices to each other and to the final output.

The .sme file is very different from a .wav sound file. The .wav sound file contains the already processed version of what the Combination switch represents. The user cannot change any part of the processing or signal path that was used to create this .wav sound file.

The .sme file, on the other hand, is a list of assignments and objects that are needed to recreate the sound with its processing and signal path where the user can at any time alter any of these “elements”, e.g., any individual DSP setting or signal path order, to change the resulting sound.

The .wav file inherently takes less processing power due to the fact that it is simply playing back a single sound that is itself the result of various processing and signal path(s). The .sme file, on the other hand, still has all of the DSP processing devices in place and must run the sound source through these processing devices along a signal path(s), which are part of the .sme file, in order to recreate the sound.

The .sme file affords the user a complete editable sound setup that is stored as a single sound file format. This .sme file is an acronym for “Save Me.”

Loading a .sme File

When a .sme file is recalled (loaded) into the software the following things happen.

A: One or more sound switches are created which contain the original Combination switch sound source(s).

B: A DSP switch is created for each DSP process that was used to create the original Combination switch. In the label for this Combination switch, each of these DSP processes can be indicated. This is not the only way this can be implemented, but it is an easy way with regards to the fact that it enables users to quickly see in the label for a Combination switch what the elements are that went into making up that sound setup.

In the case where a large number of DSP devices were used to create a Combination switch and it is not practical to show all of them on a single Combination switch, these processes can be given a code word or equivalent that can be referenced to call forth and then rebuild the original DSP switches and their processes that were used to create the Combination switch and its resulting sound.

C: The gray arrow logic links are recreated to re-establish the original signal path indicated by the Combination switches' label or equivalent.

One benefit of the .sme file is that it enables a complete sound setup to be saved as not being part of a larger automated context. For instance, such setups are common for automated recording consoles. However, these setups are contained within a larger file structure and architecture that requires that the entire architecture and file structure be reloaded before any individual portion of it can be accessed.

A .sme file can be saved as a stand alone file which requires no additional objects other than those specific objects needed to recreate the sound provided for by that .sme file. In other words, an entire mixing console or mixing console setup or video setup, or its equivalent, is not required to be loaded in order to recreate the setup called forth by the recalling of a .sme file.

What a .sme File Contains

The .sme file saves the sound source(s) and their signal path to DSP processing that has been applied to those sound source(s). The .sme file is a list of sound sources, the path from these source(s) to each DSP processes applied to them, and any and all settings required to implement this signal path. This includes, but is not limited to: the settings for these DSP devices, the input volumes of the sound sources to these DSP devices, the output volumes of these DSP devices and their sound sources, the direct output volumes of the sound sources, any gain scaling that is required to prevent clipping of the sound sources along the signal path and at the input to the output stage of the signal path.

Dragging a Sound Switch to a Timeline.

Previously mentioned was the ability to drag sound switches to a timeline to cause a play bar for the sound that is represented by that sound switch to appear. This play bar enables a user to edit the sound controlled by that sound switch. Such editing would include, the altering the positing in time that the sound plays, altering the length of the sound, removing or adding a section of sound from in the interior portion of the sound.

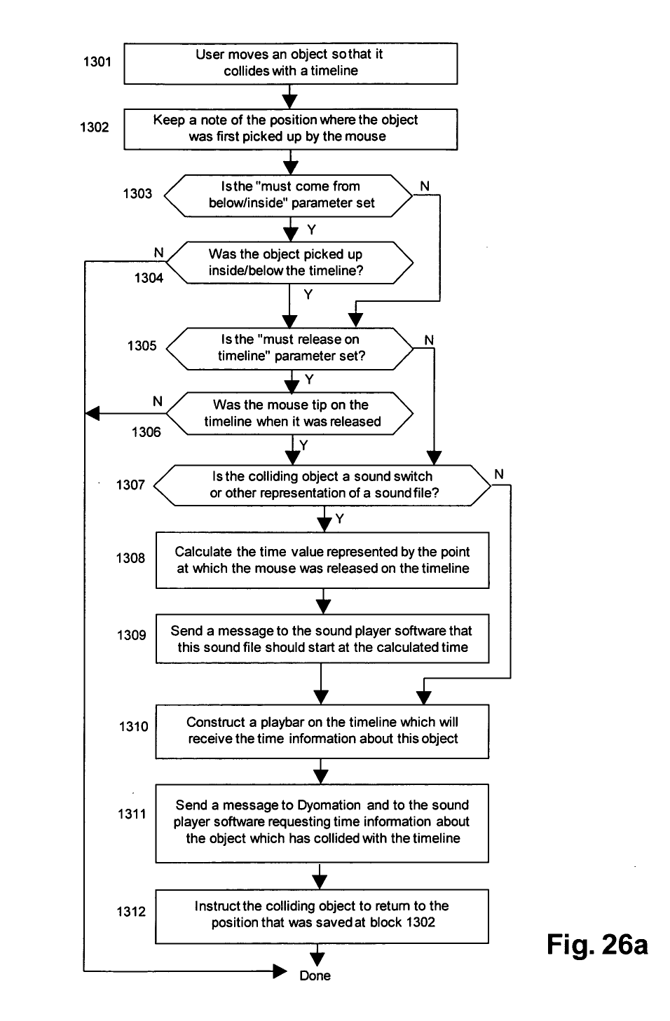

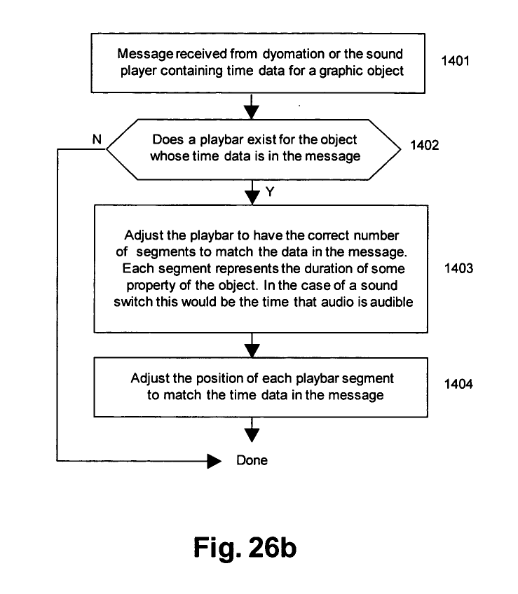

FIG. 26a explains this operation. A timeline is a graphic object which shows a period of time along a (typically) horizontal axis. Attached to a timeline can be play bars which show to the user the time extent that some object or object property exists or adopts some state. In the case of a sound file, this could be the time between when audio starts to be heard and the time at which it is no longer audible. Whatever the play bar represents can be edited by moving the end points of the play bar or its overall position on the timeline.

This flowchart describes the process for obtaining a play bar for a sound switch in accordance with an embodiment of the invention. This process is based on the detection of graphical collisions in the Blackspace environment. When the user moves and lets go of an object by clicking and dragging with the mouse. The underlying drawing surface looks for collisions between the moved object and any objects which are present at the point where the mouse was released. Each such object is instructed that the new object has collided with it.

At block 1301, a user moves an object so that it collides with a timeline.

At block 1302, the software keeps a note of the position where the object was first picked up by the mouse.

At block 1303, the software checks to see if the “must come from below/inside” parameter is set. This parameter is a user-selectable option in the Info Canvas object for a timeline.

If no, the process goes directly to block 1305.

Referring again to block 1303, if yes, then at block 1304, the software checks to see if the object was picked up inside or below the timeline.

If yes, then at block 1305, the software checks to see if the “must release on timeline” parameter is set. This parameter requires that the mouse cursor tip must be in close proximity to the timeline when a mouse up click is performed.

If yes, then at block 1306, the software checks to see if the mouse tip was on the timeline when it was released—when a mouse up click was performed.

If yes, then at block 1307, the software checks to see if the colliding object is a sound switch or other representation of a sound file.

If yes, then at block 1308, the software calculates the time value represented by the point at which the mouse was released on the timeline.

Then at block 1309, the software sends a message to the sound player software that this sound file should start at the calculated time.

Then at block 1310, the software constructs a play bar on the timeline which will receive the time information about this object.

Then at block 1311, the software sends a message to the Dyomation software and to the sound player software requesting time information about the object which has collided with the timeline. The word “Dyomation” is a trademark of the NBOR Corporation. For information about Dyomation software and related processes (previously referred to as “Drawmation”), see U.S. patent application Ser. No. 10/672,391, filed Sep. 26, 2003, entitled “System and Method of Recording and Replaying Property Changes on Graphic Elements in a Computer Environment”.

When this message is sent, the software returns to normal operations and waits for the destination of the message to send a reply. In the case of an object representing a sound file, it is the sound player software which will respond. In most other cases, it will be the Dyomation system which replies to the message. When the reply is received, the flowchart to the right is executed.

At block 1312, the software instructs the colliding object to return to the position that was saved at step 1302. Then the process ends.

Referring again to block 1306, if no, the process ends.

Referring again to block 1307, if no, the process goes directly to block 1310.

FIG. 26b explains what happens when the GUI receives a message from the sound system containing information about start and end times of the sound in accordance with an embodiment of the invention.

At block 1401, a message is received from the Dyomation software or the sound player containing time data for a graphic object.

At block 140, the software checks to see if a play bar exists for the object whose time data is in the message.

If yes, then at block 1403, the software adjusts the play bar to have the correct number of segments to match the data in the message. Each segment represents the duration of some property of the object. In the case of a sound switch, this would be the time that audio is audible.

At block 1404, the software adjusts the position of each play bar segment to match the time data in the message.

Master Output Fader

At any point in time, a user can create a Master Output Fader. To make a master output fader, a user would first create a blank switch and type the word “output” onto it and then hit the Esc key or its equivalent. At this point the switch will have the text “Output” typed onto it. When this switch is pressed, a small fader will appear onscreen with the word “Output” adjacent to it. This text could be above the fader or below or next to it. In addition, an output parameter can appear adjacent to this fader. This output parameter will change as the fader's cap is moved up or down to change the volume of the output.

Moving the fader cap for this fader adjusts the final output volume for all sound sources that are active in the system. Turning this output switch off will hide the output fader. Turning this output switch back on will again make the output fader reappear onscreen.

Text Controls can Replace DSP Switches

This software provides for the ability to enable a text object to be input onscreen and have this object call forth a DSP device and then permit a user to draw a “send to” arrow to input various sound sources to this DSP “text control” device. The text control can be treated in the same way as a DSP switch. Any operation that refers to a DSP switch herein can also refer to a text control.

To implement this feature, a user types or otherwise inputs a recognized text control onscreen and then inputs this control into the system. This could be accomplished by activating the Esc key, Enter key, by a verbal command or some other suitable command. Once inputted to the system, the software calls forth the DSP device that is designated for that text control. The assignment of DSP devices to text controls can be according to default settings or according to selections made in menus or the like by a user.

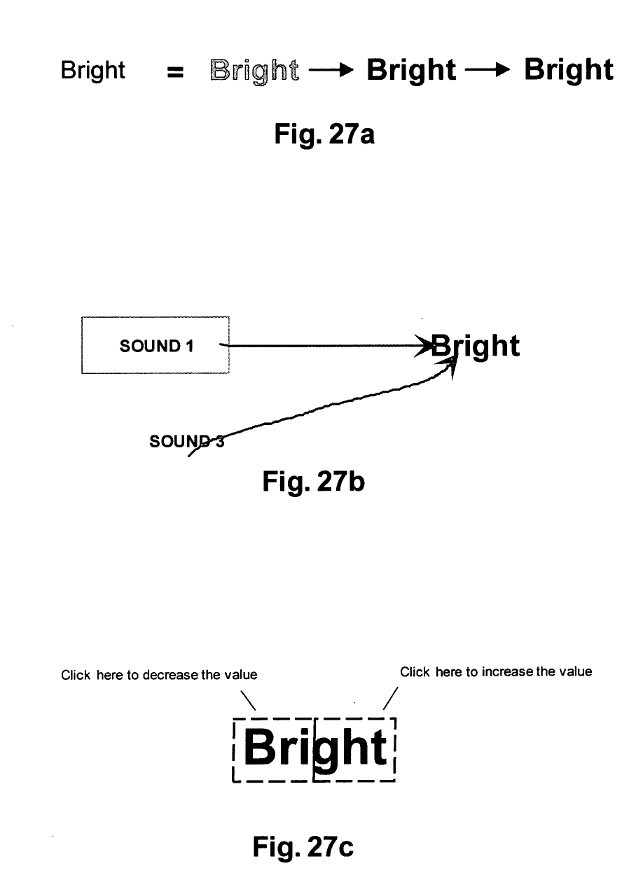

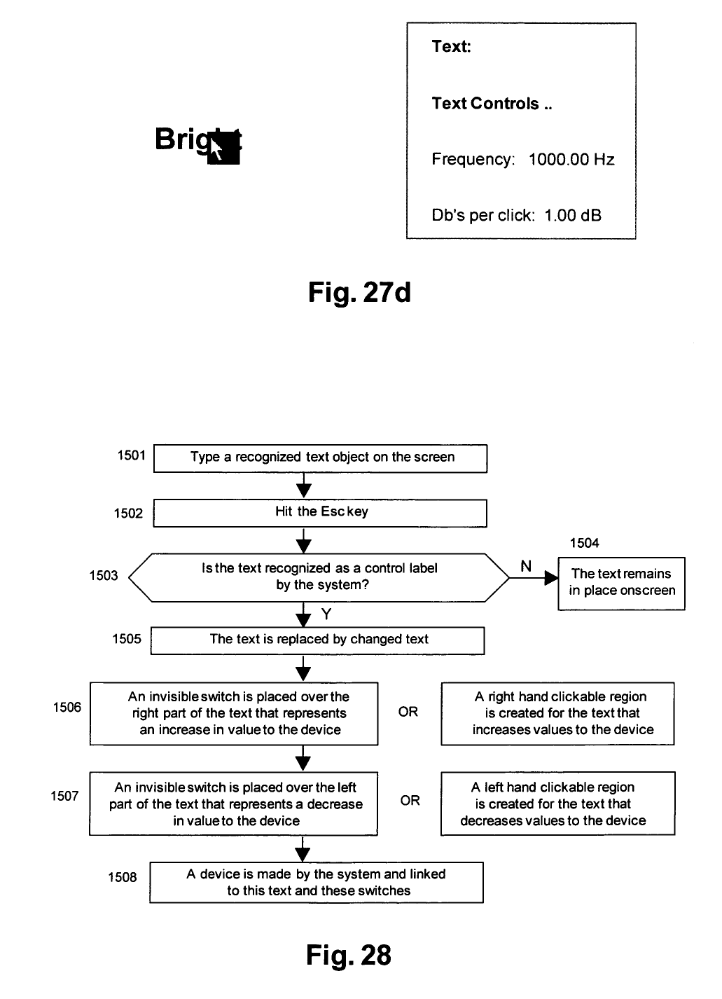

Referring to FIG. 27a, one example of a text control is the word “Bright.” To implement this control, a user would type the word “Bright” onscreen and hit the Esc key or its equivalent. This will create a bright control.

Once recognized by the system, the DSP device that is assigned to this text control, let's say it's an EQ, will be built in software and automatically activated. Right-clicking on the text control will cause the Info Canvas object for this control to appear onscreen. If the entry “Controls Hidden” is turned off, a VDACC object or its equivalent with the operational controls for this DSP device will appear onscreen. These operational controls permit the user to adjust the settings for the DSP device assigned to this text control.

When the bright control is created, the text control can change its appearance to indicate to the user that the control has been recognized by the software. For instance it can turn bold and become a different color like red. In addition, the text control can change its color for each increase or decrease in value caused by clicking on the text control. In this manner a user can see a visual indication of the increases or decreases in DSP control afforded by the text control. The word “Bright” could get progressively lighter in color as the brightness increases and gets progressively darker in color as the brightness decreases as illustrated in FIG. 27a, but any combination is possible.

Referring now to FIG. 27b, whatever can be connected to a DSP device can be connected to this text control, e.g., sound files or sound switches or faders that have sound input to them or that are controlling sounds or sound switches. Multiple sound sources can be connected to this text “bright”. The sources are summed and automatically gain-staged to avoid clipping. The connection between sound source and DSP device is made by drawing a gray “send to” arrow from the sound source to this bright text control. After the arrow is drawn and recognized, its arrowhead turns white, or the equivalent, to indicate that the software recognizes a valid context for the drawn arrow. Then the user touches this arrow's white arrowhead and the connection is made from the sound source(s) to the bright control.

This text control looks to the user as the word “bright” typed onscreen. And this is the point. This process enables users to type text onscreen and have this text actuate DSP control parameter, like boost/cut for an EQ or mid delay for a reverb, etc. Furthermore, a user is able to “hook up” a signal source, e.g., a sound file, to the input of this DSP device by simply drawing a gray “send to” arrow such that the tail of the arrow intersects the sound file and its arrow head intersects the text of the text control, namely the word “Bright.”

Another important feature of the text control is that its text has a special geometry that is recognized by the software. Referring to FIG. 27c, the right hand side of the text is recognized as a separate region from the left-hand side of the text. Let's say an EQ is the DSP device for this bright text control. Let's further say that the boost/cut parameter for this EQ is directly linked to this text control. Again this can be by way of a software default or as a result of a user selection in a menu or Info Canvas object.

To operate this text control, a user would left-click on the left side of the text control and this will cause the boost/cut of the EQ to be decreased. Similarly, clicking on the right hand side of the text control will cause the boost/cut of the EQ to be increased. There are many details that can be handled in various additional Info Canvas object or menu entries, such as which EQ band is being controlled by the text control or the ability to switch between EQ bands and use the same text control to operate them.

Getting an Info Canvas Object for the Brightness Text Control.

FIG. 27d illustrates one method of doing this. Right-click anywhere on the text control, and the Info Canvas object for that control will appear.

This Info Canvas object has an entry called: “Text Controls”. Under this category are various entries. Two such entries are: (1) Frequency 1000.00 Hz, and (2) DB's per click 6.00 dB.

To change the Frequency or DB's per click place your text cursor on the parameter that controls either value, e.g., 1000.00 Hz, and type a new parameter and then hit the Escape key or its equivalent to finish the change.

FIG. 28 is a flowchart of the process for creating a text control in accordance with an embodiment of the invention.

At block 1501, a user types a key word or phrase onscreen.

At block 1502, the user hits the Esc key to enter the phrase into the system.

At block 1503, the software checks to see if the text is recognized as a control label by the system.

If no, the text remains onscreen and no action is taken, at block 1504.

If yes, at block 1505, the text is replaced by text that has a different appearance, like bold red.

Then at block 1506, there are two choices, (a) an invisible switch is placed over the right part of the text that represents an increase in value to the device, or (b) a right hand clickable region is created for the text that increases values to the device.

Then at block 1507, there are two choices, (a) an invisible switch is placed over the left part of the text that represents a decrease in value to the device, or (b) a left hand clickable region is created for the text that decreases values to the device.

At block 1508, a device is made by the system and linked to this text and either to the invisible switches or to the clickable areas of the text.

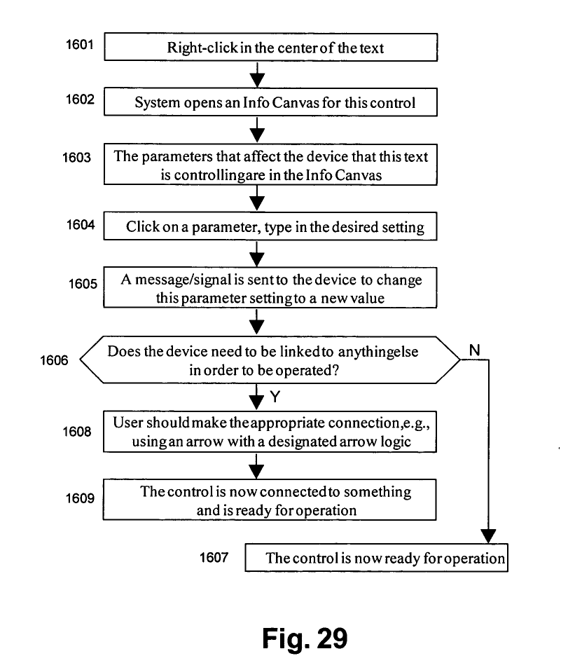

FIG. 29 is a flowchart that illustrates the setting up of a Text Control in accordance with an embodiment of the invention.

At block 1601, a user right-clicks in the center of the text (if the invisible switch method is used) or right-clicks anywhere on the text if the clickable region for the text is used. A third method is possible for creating a clickable text. This method places two invisible switches under the text and causes the text to reject left mouse clicks. This way a left-click on the text will activate one of the invisible switches below the text. In the same manner as the other approaches, the left switch will decrease values and the right switch will increase them. Of course, this could be reversed.

At block 1602, the system opens an Info Canvas object for this text control.

At block 1603, the parameter that affect the device that the text is controlling are shown in this Info Canvas object.

At block 1604, a user clicks on any of these parameters in this Info Canvas object and enters a desired setting. One method is to type a new numerical parameter into the Info Canvas object.

At block 1605, a message/signal is sent to the device to change this parameter setting to a new value.

At block 1606, the software checks to see if the device needs to be linked to anything else in order to be operated.

If no, the control is ready for operation, at block 1607.

If yes, at block 1608, the user should make the appropriate connect, e.g., drawing a “send to” arrow from a valid source to the text control.

Then, at block 1609, the control is properly connected and is ready to be used.

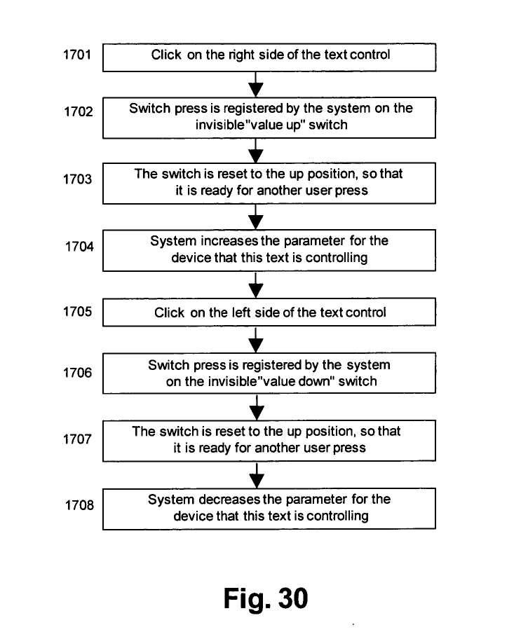

FIG. 30 is a flowchart that illustrates the operation of a text control in accordance with an embodiment of the invention.

At block 1701, the user clicks on the right side of the text control.

At block 1702, the switch press is registered by the system on the invisible “value up” switch or on the clickable region of the text that represents “value up.”

At block 1703, the switch is reset to the up position, so that it is ready for another user press.

At block 1704, the system increases the parameter for the device that this text is controlling.

At block 1705, the user clicks on the left side of the text control.

At block 1706, the switch press is registered by the system on either the invisible “value down” switch or on the region of the text that represents “value down.”

At block 1707, the switch is reset to the up position, so that it is ready for another user press.

At block 1708, the system decreases the parameter for the device that this text is controlling.

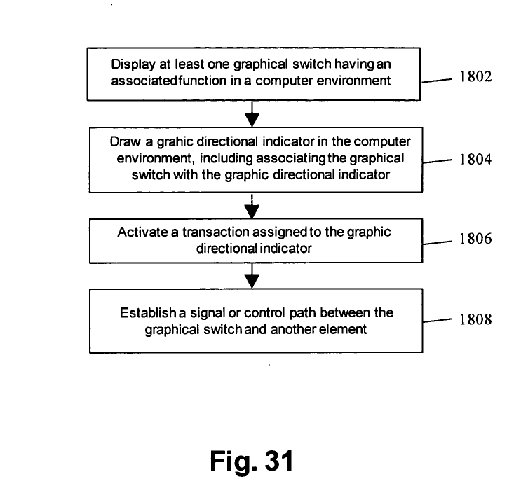

A method for performing multimedia operations in accordance with an embodiment of the invention is described with reference to a flow diagram of FIG. 31. At block 1802, at least one graphical switch having an associated function is displayed in a computer environment, e.g., a Blackspace environment. Next, at block 1804, a graphic directional indicator is drawn in the computer environment. Furthermore, at block 1804, the graphical switch is associated with the graphic directional indicator by, for example, drawing the graphic directional indicator that intersects, nearly intersects and/or substantially encircle the graphical switch. Next, at block 1806, a transaction assigned to the graphic directional indicator is activated. Next, at block 1808, a signal or control path between the graphical switch and another element is established.

An embodiment of the invention includes a storage medium, readable by a computer, tangibly embodying a program of instructions executable by the computer to perform method steps for performing multimedia operations.

Another embodiment of the invention includes an apparatus that is configured to perform the processes described herein. The apparatus may be a computing device, such as a computer, with a display device designed to perform the described multimedia operations.

Although specific embodiments of the invention have been described and illustrated, the invention is not to be limited to the specific forms or arrangements of parts so described and illustrated. The scope of the invention is to be defined by the claims appended hereto and their equivalents.

1. A method for performing multimedia operations, said method comprising:
displaying at least one graphical switch having an associated function in a computer environment;
drawing a graphic directional indicator in said computer environment, including associating said at least one graphical switch with said graphic directional indicator; and
activating a transaction assigned to said graphic directional indicator; and
establishing a signal path between said at least one graphical switch and another element.

2. A method for performing multimedia operations, said method comprising:
displaying at least one graphical switch having an associated function in a computer environment;
drawing a graphic directional indicator in said computer environment, including associating said at least one graphical switch with said graphic directional indicator; and
activating a transaction assigned to said graphic directional indicator; and
establishing a control path between said at least one graphical switch and another element.

3. A storage medium readable by a computer, tangibly embodying a program of instructions executable by said computer to perform method steps for performing multimedia operations, said method steps comprising:
displaying at least one graphical switch having an associated function in a computer environment;
drawing a graphic directional indicator in said computer environment, including associating said at least one graphical switch with said graphic directional indicator; and
activating a transaction assigned to said graphic directional indicator; and
establishing a signal path between said at least one graphical switch and another element.
